(19) United States
(12) Patent Application Publication
(10) Pub. No.: US 2015/0066678 A1
(43) Pub. Date: Mar. 5, 2015

(54) ELECTRONIC SYSTEM WITH TEMPORAL BID MECHANISM AND METHOD OF OPERATION THEREOF

(71) Applicant: Pete Chris Advisors, Inc., San Francisco, CA (US)

(72) Inventor: Charles Ogilvie, San Francisco, CA (US)

(73) Assignee: Pete Chris Advisors, Inc., San Francisco, CA (US)

(21) Appl. No.: 14/230,243

(22) Filed: Mar. 31, 2014

Related U.S. Application Data
(60) Provisional application No. 61/870,239, filed on Aug. 27, 2013.

(51) Int. Cl. G06Q 30/08; G06Q 30/06

(52) U.S. Cl. CPC G06Q 30/08; G06Q 30/0633
USPC 705/26.3

(57) ABSTRACT

An electronic system includes: a control unit, configured to generate a geo-fence around a destination location for distributing an order for a good to a goods provider located within the geo-fence; identify a temporal bid from the goods provider for bidding on the order; determine a winning bid based on a bid time of the temporal bid; and a display unit, coupled to the control unit, configured to display the winning bid.

### CROSS-REFERENCE TO RELATED APPLICATION

This application claims the benefit of U.S. Provisional Patent Application Ser. No. 61/870,239 filed Aug. 27, 2013, and the subject matter thereof is incorporated herein by reference thereto.

### TECHNICAL FIELD

The present invention relates generally to an electronic system, and more particularly to a system with a temporal bid mechanism.

### BACKGROUND

Modern portable consumer and industrial electronics, especially client devices such as computing systems, electronic systems, mobile phones, tablet computers, and combination devices, are providing increasing levels of functionality to support modern life including providing a platform for the sale and purchase of goods. Research and development in the existing technologies can take myriad directions.

However, the hectic pace of today's modern lifestyle has made time the most precious good. This represents challenges of ensuring businesses and organizations can meet the demands of consumers without unnecessary delay.

Thus, a need still remains for an electronic system with a temporal bid mechanism appropriate for today's devices. In view of the ever-increasing commercial competitive pressures, along with growing consumer expectations and the diminishing opportunities for meaningful product differentiation in the marketplace, it is increasingly critical that answers be found to these problems. Additionally, the need to reduce costs, improve efficiencies and performance, and meet competitive pressures adds an even greater urgency to the critical necessity for finding answers to these problems.

Solutions to these problems have been long sought but prior developments have not taught or suggested any solutions and, thus, solutions to these problems have long eluded those skilled in the art.

### SUMMARY

An embodiment of the present invention provides an electronic system, including: a control unit, configured to generate a geo-fence around a destination location for distributing an order for a good to a goods provider located within the geo-fence; identify a temporal bid for bidding on the order from the goods provider; determine a winning bid based on a bid time of the temporal bid; and a display unit, coupled to the control unit, configured to display the winning bid.

An embodiment of the present invention provides a method of operation of an electronic system including: generating, with a control unit, a geo-fence around a destination location for distributing an order for a good to a goods provider located within the geo-fence; identifying a temporal bid for bidding on the order from the goods provider; determining a winning bid based on a bid time of the temporal bid; and displaying, with a display unit, the winning bid.

An embodiment of the present invention provides a non-transitory computer readable medium including: generating a geo-fence around a destination location for distributing an order for a good to a goods provider located within the geo-fence; identifying a temporal bid for bidding on the order from the goods provider; determining a winning bid based on a bid time of the temporal bid; and displaying the winning bid.

Certain embodiments of the invention have other steps or elements in addition to or in place of those mentioned above. The steps or element will become apparent to those skilled in the art from a reading of the following detailed description when taken with reference to the accompanying drawings.

### BRIEF DESCRIPTION OF THE DRAWINGS

FIG. 1 is an electronic system with a temporal bid mechanism in an embodiment of the present invention.

FIG. 2 is an example of a display interface of the electronic system.

FIG. 3 is another example of a display interface of the electronic system.

FIG. 4 is another example of a display interface of the electronic system.

FIG. 5 is another example of a display interface of the electronic system.

FIG. 6 is another example of a display interface of the electronic system.

FIG. 7 is another example of a display interface of the electronic system.

FIG. 8 is another example of a display interface of the electronic system.

FIG. 9 is another example of a display interface of the electronic system.

FIG. 10 is an exemplary block diagram of the electronic system.

FIG. 11 is a control flow of the electronic system.

FIG. 12 is a flow chart of a method of operation of the electronic system in a further embodiment of the present invention.

### DETAILED DESCRIPTION

The following embodiments are described in sufficient detail to enable those skilled in the art to make and use the invention. It is to be understood that other embodiments would be evident based on the present disclosure, and that system, process, or mechanical changes may be made without departing from the scope of the present invention.

In the following description, numerous specific details are given to provide a thorough understanding of the invention. However, it will be apparent that the invention may be practiced without these specific details. In order to avoid obscuring the embodiment of the present invention, some well-known circuits, system configurations, and process steps are not disclosed in detail.

The drawings showing embodiments of the system are semi-diagrammatic, and not to scale and, particularly, some of the dimensions are for the clarity of presentation and are shown exaggerated in the drawing figures. Similarly, although the views in the drawings for ease of description generally show similar orientations, this depiction in the figures is arbitrary for the most part. Generally, the invention can be operated in any orientation.

The term “relevant information” referred to herein includes the navigation information described as well as information relating to points of interest to the user, such as local business, hours of businesses, types of businesses, advertised specials, traffic information, maps, local events, and nearby community or personal information.

The term “module” referred to herein can include software, hardware, or a combination thereof in the embodiment of the present invention in accordance with the context in which the term is used. For example, the software can be machine code, firmware, embedded code, and application software. Also for example, the hardware can be circuitry, processor, computer, integrated circuit, integrated circuit cores, a pressure sensor, an inertial sensor, a microelectromechanical system (MEMS), passive devices, or a combination thereof.

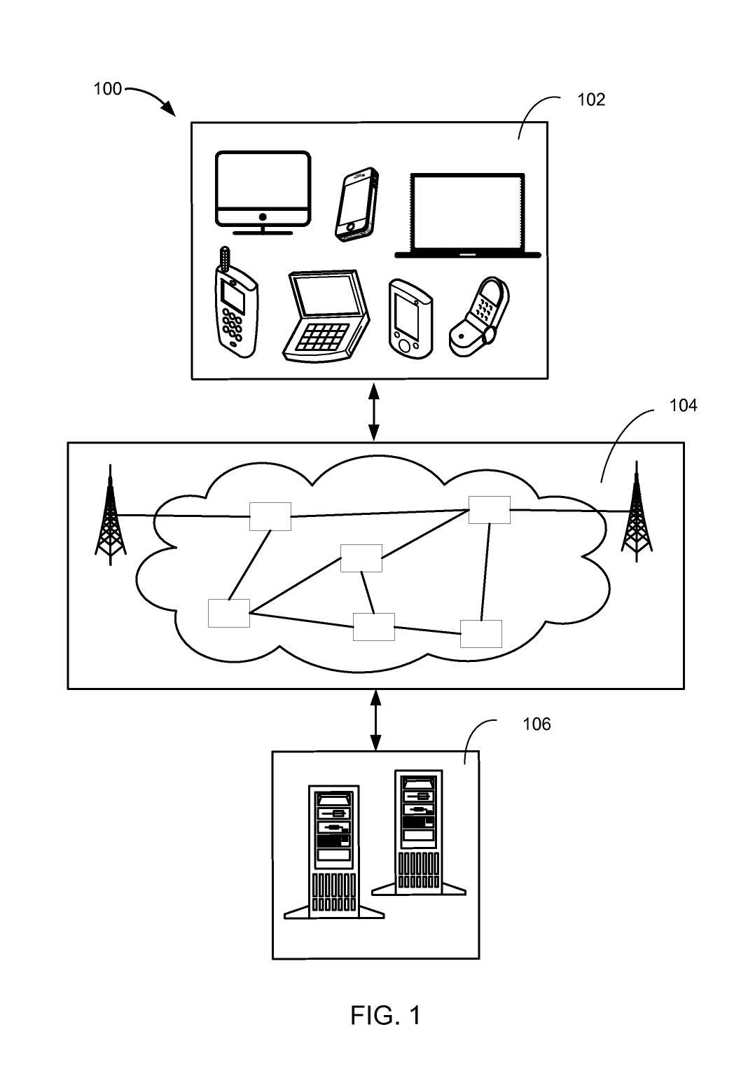

Referring now to FIG. 1, therein is shown an electronic system 100 with a temporal bid mechanism in an embodiment of the present invention. The electronic system 100 includes a first device 102, such as a client or a server, connected to a second device 106, such as a client or server, with a communication path 104, such as a wireless or wired network.

For example, the first device 102 can be of any of a variety of mobile devices, such as a cellular phone, a tablet device, a smartphone, a wearable device, a personal digital assistant, a notebook computer, an automotive telematic navigation system, or other multi-functional mobile communication or entertainment device. The first device 102 can couple to the communication path 104 to communicate with the second device 106.

For illustrative purposes, the electronic system 100 is described with the first device 102 as a computing device, although it is understood that the first device 102 can be different types of computing devices. For example, the first device 102 can also be a server, a server farm, or a desktop computer.

The second device 106 can be any of a variety of centralized or decentralized computing devices. For example, the second device 106 can be a computer, grid computing resources, a virtualized computer resource, cloud computing resource, routers, switches, peer-to-peer distributed computing devices, or a combination thereof.

The second device 106 can be centralized in a single computer room, distributed across different rooms, distributed across different geographical locations, embedded within a telecommunications network. The second device 106 can have a means for coupling with the communication path 104 to communicate with the first device 102. The second device 106 can also be a client type device as described for the first device 102.

In another example, the first device 102 can be a particularized machine, such as a mainframe, a server, a cluster server, a rack mounted server, or a blade server, or as more specific examples, an IBM System z10™ Business Class mainframe or a HP ProLiant ML™ server. For illustrative purposes, the electronic system 100 is described with the second device 106 as a non-mobile computing device, although it is understood that the second device 106 can be different types of computing devices.

For example, the second device 106 can also be a mobile computing device, such as a notebook computer, a wearable device, a thin client device, a netbook, a smartphone, a personal digital assistant, a cellular phone, and as specific examples, an Apple iPhone™, a Samsung Galaxy™, a Microsoft Windows Phone™, an HTC One™, or a Motorola Moto™. The second device 106 can be a standalone device, or can be incorporated with a vehicle, for example a car, truck, bus, or train.

Also for illustrative purposes, the electronic system 100 is shown with the second device 106 and the first device 102 as end points of the communication path 104, although it is understood that the electronic system 100 can have a different partition between the first device 102, the second device 106, and the communication path 104. For example, the first device 102, the second device 106, or a combination thereof can also function as part of the communication path 104.

The communication path 104 can be a variety of networks. For example, the communication path 104 can include wireless communication, wired communication, optical, ultrasonic, or a combination thereof. Satellite communication, cellular communication, Bluetooth, Infrared Data Association standard (IrDA), wireless fidelity (WiFi), and worldwide interoperability for microwave access (WiMAX) are examples of wireless communication that can be included in the communication path 104. Ethernet, digital subscriber line (DSL), fiber to the home (FTTH), and plain old telephone service (POTS) are examples of wired communication that can be included in the communication path 104.

Further, the communication path 104 can traverse a number of network topologies and distances. For example, the communication path 104 can include direct connection, personal area network (PAN), local area network (LAN), metropolitan area network (MAN), wide area network (WAN) or any combination thereof.

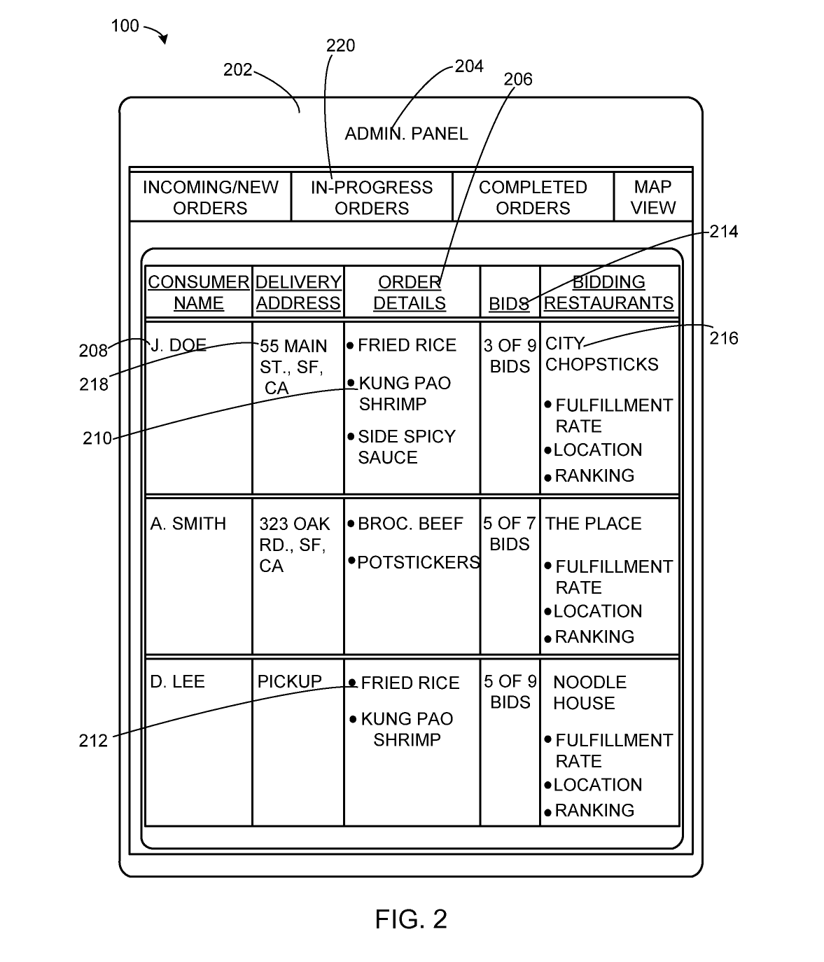

Referring now to FIG. 2 therein is shown an example of a display interface 202 of the first device 102 showing an administrative page 204. The administrative page 204 is an overview page showing the status of an order 206 from a consumer 208. The electronic system 100 can display the administrative page 204 to an administrator of the electronic system 100 or a user of the electronic system 100.

The order 206 is a request for an item. For example, the order 206 can include a good 210 desired by the consumer 208. As a more specific example, the order 206 can be a request for a physical item such as a take-out order, a delivery order, a restaurant order, a pharmacy order, a floral order, a parts order, a bakery order, a catering order, a grocery order, a shopping card order, or a combination thereof. As an additional example, the order 206 can be a request for a virtual item such as a virtual object or virtual resource.

The consumer 208 is person or device requesting the good 210. For example, the consumer 208 can be a user of the electronic system 100 or a device in the electronic system 100.

The good 210 is an item. The good 210 can be a physical good or a virtual good. For example, the good 210 can include a food item such as a restaurant dish, a home-cooked dish, a baked good, a catered dish, or a combination thereof. In addition, the good 210 can include an assembled item such as a prescription, a floral arrangement, a grocery basket, a shopping basket, or a combination thereof.

The good 210 can also include a commoditized item 212. The commoditized item 212 is an unspecialized item or product capable of being produced in large quantities. The commoditized item 212 can be characterized by the fungibility of the item or product. For example, the commoditized item 212 can include a food item capable of being cooked in bulk. Also for example, the commoditized item 212 can include a food item capable of being cooked by multiple restaurants, kitchens, dining establishments, or a combination thereof. In addition, the commoditized item 212 can include an item where the price of the item is determined by a third party, such as the electronic system 100, unrelated to the preparer or originator of the item.

As a more specific example, the commoditized item 212 can include a dish from a Chinese restaurant. As a further example, the commoditized item 212 can include an auto part from an auto parts provider. As yet another example, the commoditized item 212 can include a flower from a florist.

The administrative page 204 can also display a temporal bid 214 received from a goods provider 216 for completing the order 206. The temporal bid 214 is an offer from the goods provider 216 to prepare or produce the good 210. The temporal bid 214 can include an estimated time for completing the order 206. For example, the temporal bid 214 can be an offer from the goods provider 216 to prepare or provide the good 210 in 10 minutes. As a more specific example, the temporal bid 214 can be an offer from a Chinese restaurant to cook an order of fried rice in 10 minutes.

The goods provider 216 is a person or organization capable of preparing or providing the good 210. For example, the goods provider 216 can include a dining establishment, a kitchen, a bakery, a caterer, a pharmacy, an auto parts provider, a grocery store, a drugstore, a retail store, or a combination thereof. As an additional example, the goods provider 216 can include a chef or cook, a baker, a pharmacist, an auto parts dealer, a farmer or food dealer, a shopper, or a combination thereof.

The administrative page 204 can display a destination location 218 for the order 206. The destination location 218 is a geographic location where the order 206 is to be delivered or picked up. For example, the destination location 218 can be a geographic location of the consumer 208. As a more specific example, the destination location 218 can include a residential address, an occupational address, a commercial address, a landmark, or a combination thereof. The destination location 218 can be a geographic location of the goods provider 216 when the order 206 is a pickup order.

The administrative page 204 can also display pending orders 220 handled by the electronic system 100. The pending orders 220 are instances of the order 206 being distributed for bidding or being prepared by the goods provider 216. The pending orders 220 can include a restaurant order currently being cooked by a restaurant, a grocery order receiving instances of the temporal bid 214 from grocery stores, or a floral order being placed by the consumer 208.

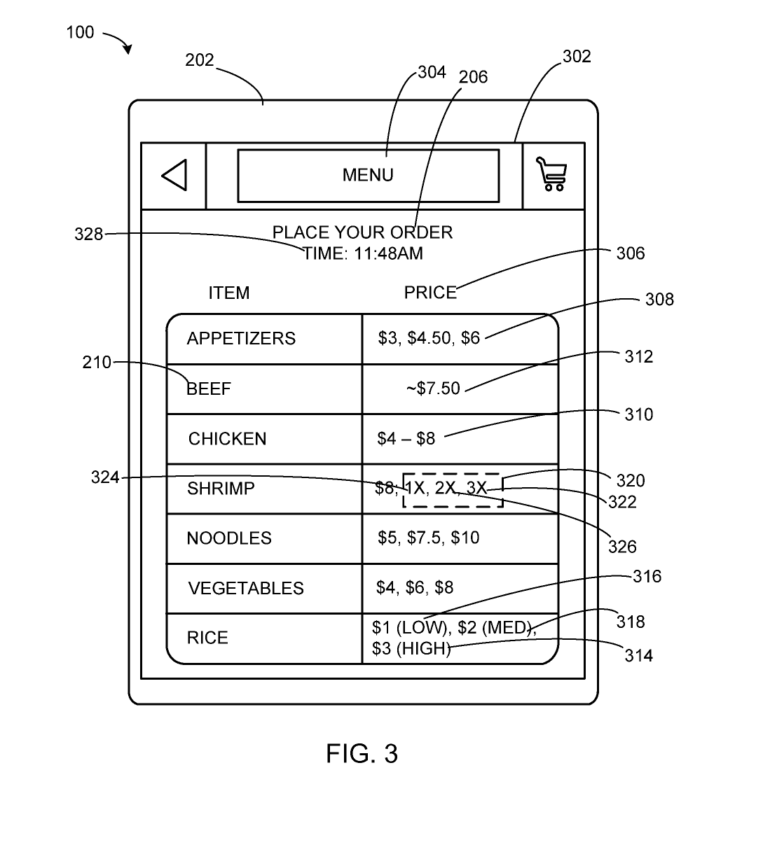

Referring now to FIG. 3 therein is shown another example of the display interface 202 of the first device 102 showing an order page 302. The order page 302 shows items available for purchase on the electronic system 100. The electronic system 100 can display the order page 302 to the consumer 208 of FIG. 2 or another user of the electronic system 100.

The order page 302 can include a goods list 304. The goods list 304 is a listing or catalog of items available for purchase. For example, the goods list 304 can include a dining menu, a restaurant menu, a takeout menu, a prescription list, a bakery menu, a catering menu, an auto parts list, a grocery list, a retail list, or a combination thereof.

The goods list 304 can include an adjustable price 306 for the good 210. The adjustable price 306 is a variable price for an item or product. The adjustable price 306 can include a price bracket 308, a price range 310, an approximate price 312, or a combination thereof. The price bracket 308 include prices of items broken up by tiers. For example, the price bracket 308 can include multiple prices for one food item or dish on a menu.

The price bracket 308 can also include a high price 314, an intermediate price 318, a low price 316, or a combination thereof. The high price 314 can be the highest price in the price bracket 308, the low price 316 can be the lowest price in the price bracket 308, and the intermediate price 318 can be a price in between the high price 314 and the low price 316.

The price range 310 can include a span of prices between a minimum price and a maximum price. For example, the price range 310 can be a range of prices in between the low price 316 and the high price 314. As a more specific example, the price range 310 can include a range of prices between $2 and $6. The approximate price 312 is an estimated price for the good 210. The approximate price 312 can be a price within the price bracket 308, the price range 310, or a combination thereof.

The goods list 304 can also include a price multiplier 320. The price multiplier 320 is a numerical multiplier for adjusting a price of an item or product. For example, the price multiplier 320 can include a high multiplier 322, a low multiplier 324, an intermediate multiplier, or a combination thereof. The high multiplier 322 can be the highest instance of the price multiplier 320, the low multiplier 324 can be the lowest instance of the price multiplier 320, and the intermediate multiplier 326 can be a value between the low multiplier 324 and the high multiplier 322.

The order page 302 can include an order time 328 associated with the order 206. The order time 328 can be the time corresponding to a placement of the order 206. In addition, the order time 328 can be the time corresponding to a receipt of the order 206 by the electronic system 100. For illustrative purposes, the order page 302 is shown with the price bracket 308, the price range 310, and the approximate price 312 on the same page, however it is understood that the order page 302 can show any combination of the price bracket 308, the price range 310, or the approximate price 312 together or separate.

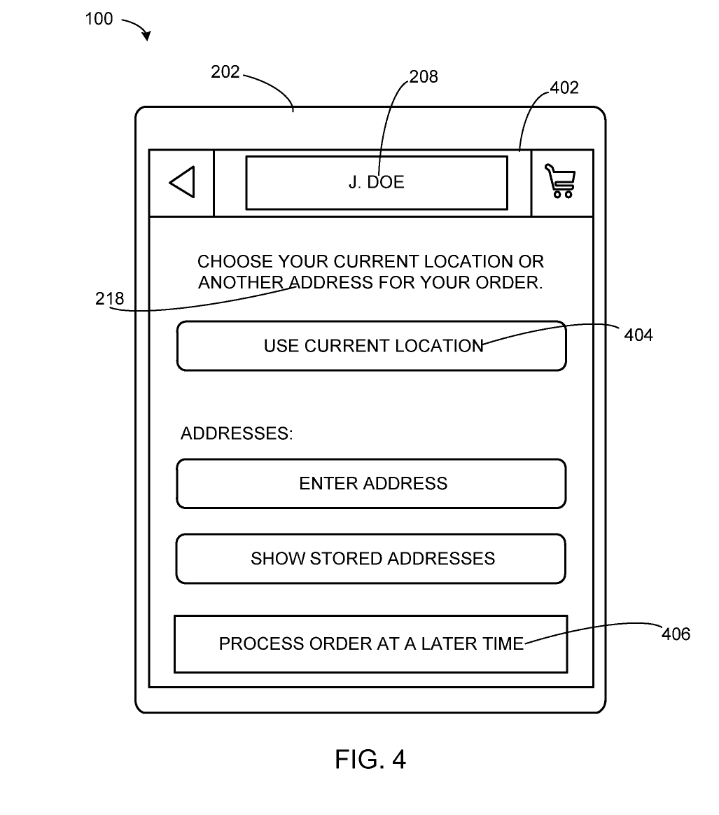

Referring now to FIG. 4 therein is shown another example of the display interface 202 of the first device 102 showing a location page 402. The location page 402 receives the destination location 218 from the consumer 208 or another user of the electronic system 100. The electronic system 100 can display the location page 402 to the consumer 208 or another user of the electronic system 100.

The electronic system 100 can receive the destination location 218 from the consumer 208 through the location page 402. In addition, the electronic system 100 can determine a current location 404 of the consumer as the destination location 218. The current location 404 is the present physical location of the consumer 208. The electronic system 100 can receive the current location 404 from the consumer 208 or determine the current location 404 through a component of the first device 102 of FIG. 1.

The location page 402 can also include a hold icon 406. The electronic system 100 can receive a request from the consumer 208 to hold the order 206 until a subsequent time through the hold icon 406. The sections below will discuss holding the order 206 in more detail.

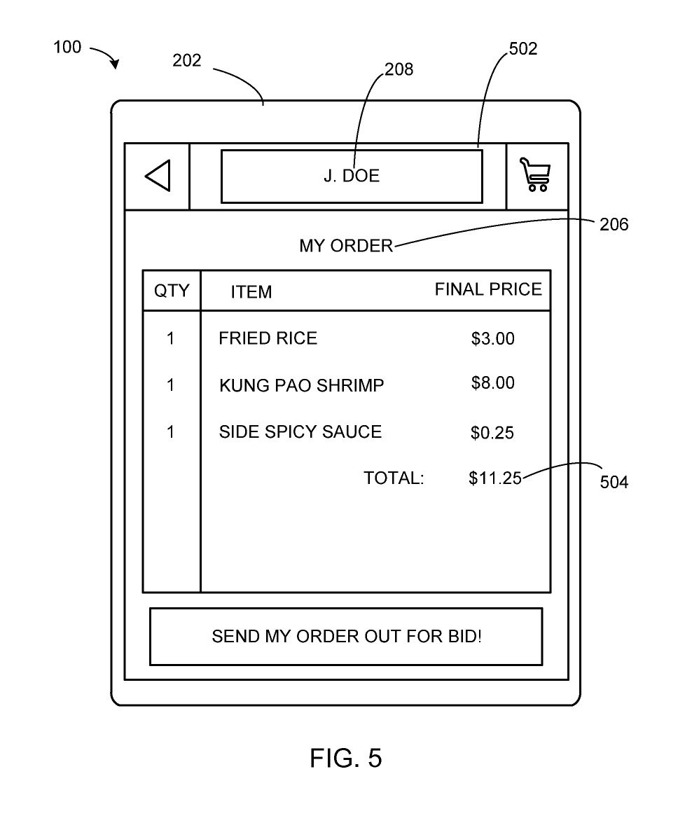

Referring now to FIG. 5 therein is shown another example of the display interface 202 of the first device 102 showing a compiled order page 502. The compiled order page 502 shows a finished instance of the order 206 received from the consumer 208. The electronic system 100 can display the compiled order page 502 to the consumer 208 or another user of the electronic system 100.

The compiled order page 502 can include a final price 504 of the order 206. The final price 504 is a non-variable price of an item or product. For example, the final price 504 can be an ultimate price of the order 206. The final price 504 can be a cumulative price for the good 210 or a plurality of the good 210 included in the order 206. The final price 504 can be based on the adjustable price 306 or a modified instance of the adjustable price 306 of FIG. 3.

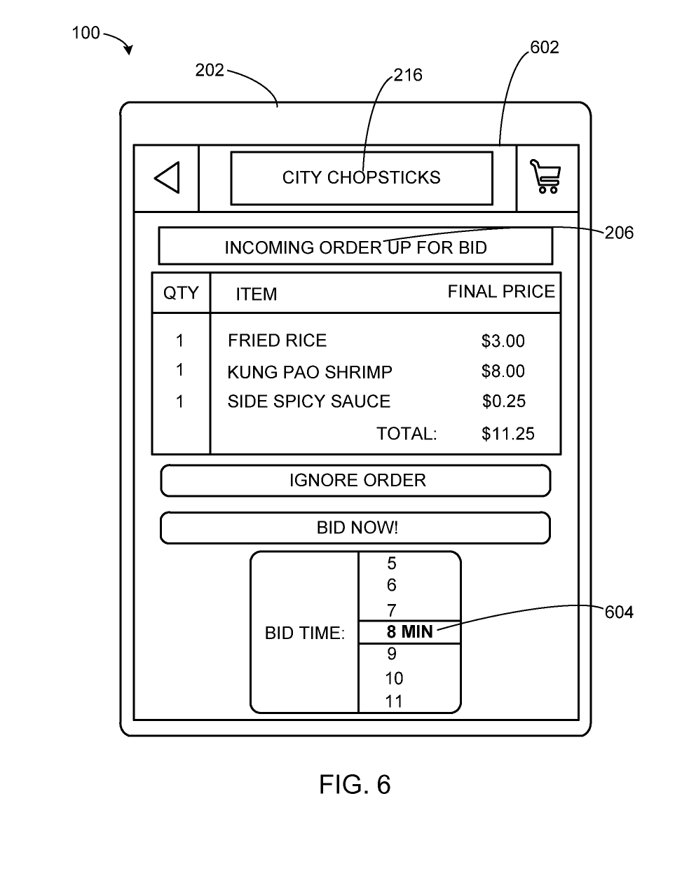

Referring now to FIG. 6 therein is shown another example of the display interface 202 of the first device 102 showing a bid page 602. The electronic system 100 receives the temporal bid 214 of FIG. 1 from the goods provider 216 through the bid page 602. The electronic system 100 can display the bid page 602 to the goods provider 216 or another user of the electronic system 100.

The bid page 602 can include a bid time 604 of the temporal bid 214. The bid time 604 is an estimated period of time for completing the order 206. The bid time 604 can be expressed in minutes, hours, seconds, time duration, or a combination thereof. The electronic system 100 can receive the bid time 604 through a user input of the goods provider 216.

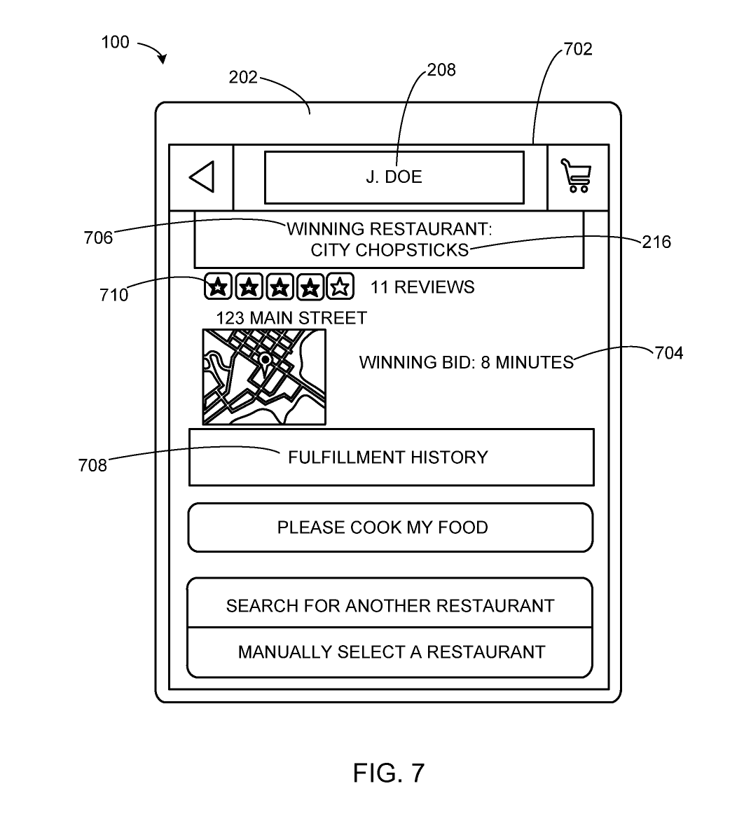

Referring now to FIG. 7 therein is shown another example of the display interface 202 of the first device 102 showing a win confirmation page 702. The win confirmation page 702 shows a winning bid 704 submitted by the goods provider 216. The electronic system 100 can display the win confirmation page 702 to the consumer 208 or another user of the electronic system 100.

The winning bid 704 is a successful instance of the temporal bid 214 chosen over other instances of the temporal bid 214. For example, the winning bid 704 can be the temporal bid 214 with the lowest instance of the bid time 604. The win confirmation page 702 can also display a winner 706 associated with the winning bid 704. The winner 706 is the goods provider 216 responsible for the submission of the winning bid 704. For example, the winner 706 can be a restaurant responsible for the submission of the winning bid 704 for a takeout order. As an additional example, the winner 706 can be a florist responsible for the submission of the winning bid 704 for a bouquet order.

The win confirmation page 702 can also include a fulfillment history 708 of the goods provider 216, a review rating 710, or a combination thereof. The fulfillment history 708 is a record of past orders completed by the goods provider 216. The fulfillment history 708 can include data on how many orders have or have not been completed within the bid time 604 promised by the goods provider 216 in the temporal bid 214. In addition, the fulfillment history 708 can include information on the amount of time exceeded by the goods provider 216 in all instances where the order was not completed within the bid time 604.

For example, the fulfillment history 708 of a restaurant can include data on all instances when the restaurant did not cook a dish within the bid time 604 promised by the temporal bid 214 submitted by the restaurant. In this example, the fulfillment history 708 can also include data on the time differential between the bid time 604 and a completion time of the order 206 of FIG. 2. For example, the time differential between the bid time 604 and the completion time of the order 206 can be expressed as hours, minutes, seconds, or a combination thereof.

The review rating 710 is a rating of the goods provider 216 from a review service. The review rating 710 can be a rating from an external review service such as Yelp™, AngiesList™, or a combination thereof. The review rating 710 can also be an internal review from the consumer 208 or users of the electronic system 100. The review rating 710 can include a star rating, a numerical rating, a percentage rating, or a combination thereof. For example, the star rating can be based on a four star or five star rating scale.

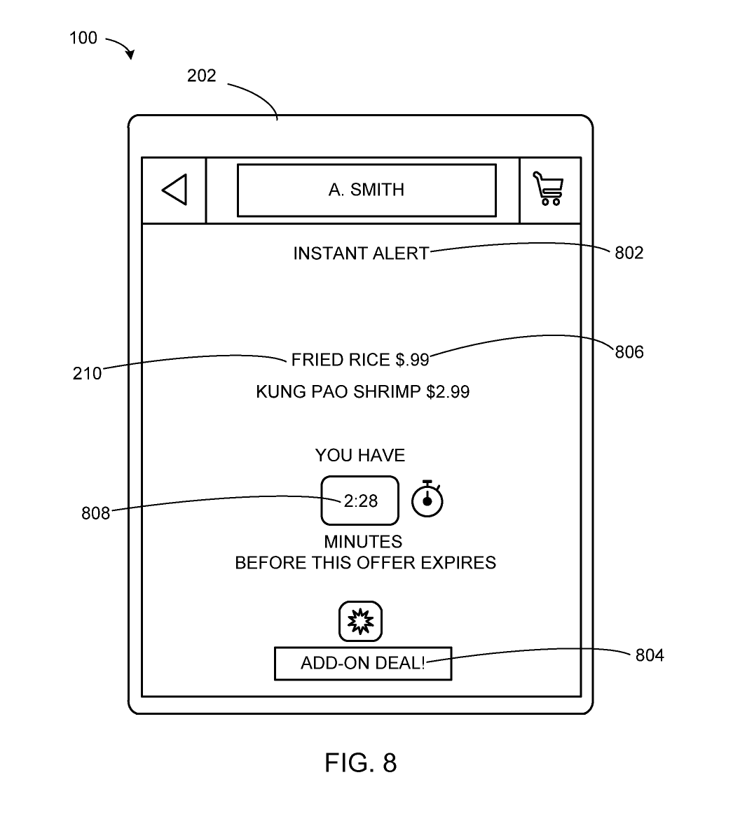

Referring now to FIG. 8 therein is shown another example of the display interface 202 of the first device 102 showing an alert 802. The alert 802 is a notification including a commercial content. For example, the alert 802 can be a push notification, a pop-up window, a message window, an audio signal, a text message, a haptic notification, or a combination thereof. The electronic system 100 can send the alert 802 to a user of the electronic system 100, the consumer 208 of FIG. 2, or a combination thereof.

The alert 802 can include an add-on offer 804. The add-on offer 804 is a commercial promotion associated with the order 206 of FIG. 2 provided to a user of the electronic system 100. For example, the add-on offer 804 can include the good 210 included in the order 206 received from the consumer 208. As an additional example, the add-on offer 804 can include a smaller portion or instance of the good 210 included in the order 206.

The add-on offer 804 can include a discount price 806 and an expiration time 808. The discount price 806 is a price lower than the final price 504 of FIG. 5. The electronic system 100 can determine the discount price 806 based on the final price 504. For example, the electronic system 100 can set the discount price 806 as half of the final price 504. The expiration time 808 is a time period when the add-on offer 804 expires. The electronic system 100 can display the expiration time 808 through a countdown timer presented in the alert 802.

As a more specific example, the order 206 can include a dish of Kung Pao shrimp from a Chinese restaurant at the intermediate price 318 of FIG. 3. In this example, the add-on offer 804 can include a promotion for the same dish of Kung Pao shrimp at the discount price 806 of the low price 316 of FIG. 3. As an additional example, the order 206 can include a floral arrangement order of a dozen roses for $30.00. In this example, the add-on offer 804 can include a promotion for one rose for the discount price 806 of $2.00.

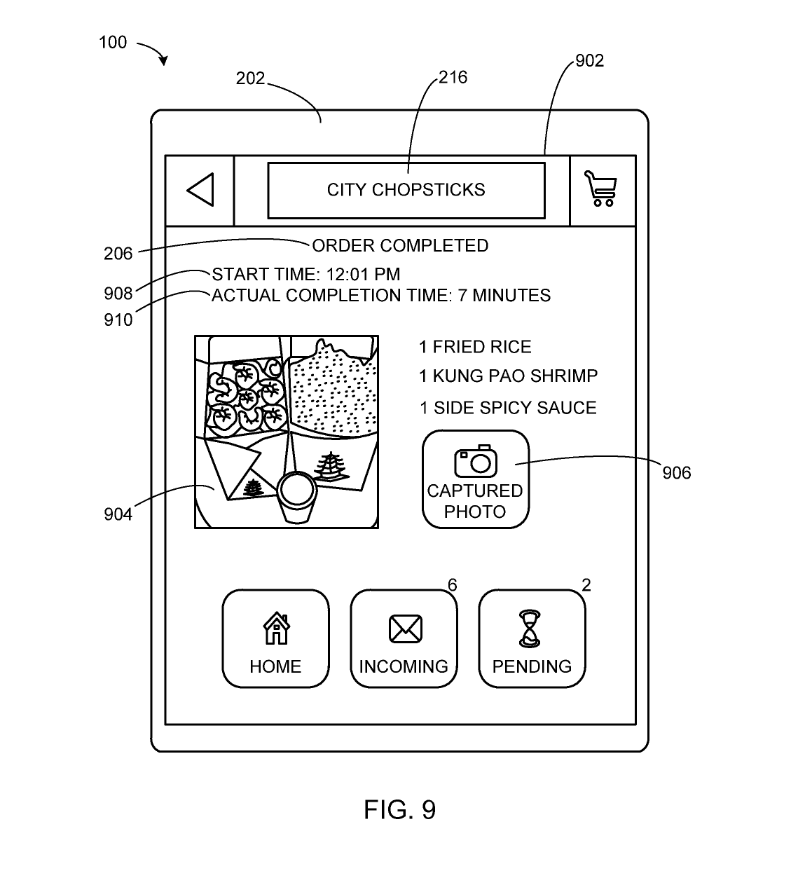

Referring now to FIG. 9 therein is shown another example of the display interface 202 of the first device 102 showing an order confirmation page 902. The order confirmation page 902 shows a completed instance of the order 206. The electronic system 100 can display the order confirmation page 902 to the goods provider 216 or a user of the electronic system 100.

The order confirmation page 902 can display an evidentiary content 904 of the order 206. The evidentiary content 904 is content depicting one or more products or items. For example, the evidentiary content 904 can include an image, a video, a multimedia content, or a combination thereof of the order 206.

The goods provider 216 can capture the evidentiary content 904 through a camera functionality 906. The camera functionality 906 is for initiating a camera or video component of a device such as the first device 102, the second device 106, or a combination thereof. The goods provider 216 can apply a user input such as a click input, a gesture input, a swipe input, or a combination thereof to the camera functionality 906 to capture the evidentiary content 904. The electronic system 100 can then transmit the evidentiary content 904 to the consumer 208 of FIG. 2.

The order confirmation page 902 can also show a start time 908 for the order 206 and an actual completion time 910. The start time 908 is a time at which the goods provider 216 begins to create or provide the good 210 indicated in the order 206. For example, the electronic system 100 can record the start time 908 as soon as the goods provider 216 is told to start on the order 206. The actual completion time 910 is a time period indicating how long it took the goods provider 216 to prepare the order 206. The actual completion time 910 can be expressed in hours, minutes, seconds, or a combination thereof.

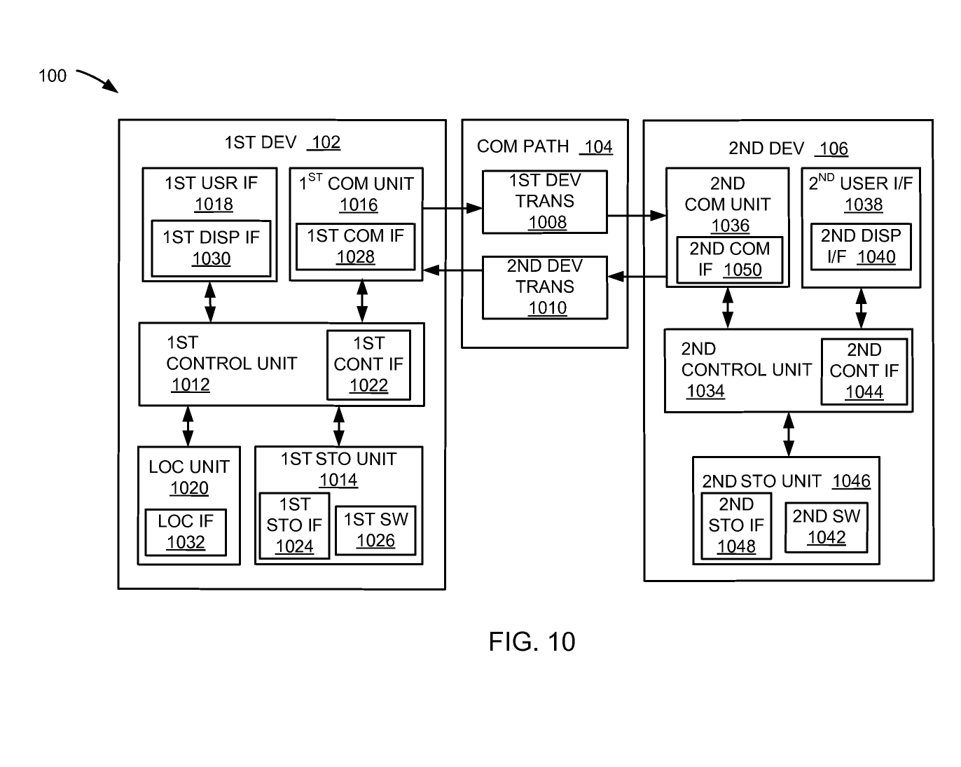

Referring now to FIG. 10 therein is shown an exemplary block diagram of the electronic system 100. The electronic system 100 can include the first device 102, the communication path 104, and the second device 106. The first device 102 can send information in a first device transmission 1008 over the communication path 104 to the second device 106. The second device 106 can send information in a second device transmission 1010 over the communication path 104 to the first device 102.

For illustrative purposes, the electronic system 100 is shown with the first device 102 as a client device, although it is understood that the electronic system 100 can have the first device 102 as a different type of device. For example, the first device 102 can be a server.

Also for illustrative purposes, the electronic system 100 is shown with the second device 106 as a server, although it is understood that the electronic system 100 can have the second device 106 as a different type of device. For example, the second device 106 can be a client device.

For brevity of description in this embodiment of the present invention, the first device 102 will be described as a client device and the second device 106 will be described as a server device. The present invention is not limited to this selection for the type of devices. The selection is an example of the present invention.

The first device 102 can include a first control unit 1012, a first storage unit 1014, a first communication unit 1016, a first user interface 1018, and a location unit 1020. The first device 102 can be similarly described by the first device 102.

The first control unit 1012 can include a first control interface 1022. The first control unit 1012 can execute a first software 1026 to provide the intelligence of the electronic system 100. The first control unit 1012 can be implemented in a number of different manners. For example, the first control unit 1012 can be a processor, an embedded processor, a microprocessor, a hardware control logic, a hardware finite state machine (FSM), a digital signal processor (DSP), or a combination thereof. The first control interface 1022 can be used for communication between the first control unit 1012 and other functional units in the first device 102. The first control interface 1022 can also be used for communication that is external to the first device 102.

The first control interface 1022 can receive information from the other functional units or from external sources, or can transmit information to the other functional units or to external destinations. The external sources and the external destinations refer to sources and destinations external to the first device 102.

The first control interface 1022 can be implemented in different ways and can include different implementations depending on which functional units or external units are being interfaced with the first control interface 1022. For example, the first control interface 1022 can be implemented with a pressure sensor, an inertial sensor, a microelectromechanical system (MEMS), optical circuitry, waveguides, wireless circuitry, wireline circuitry, or a combination thereof.

The location unit 1020 can generate a location information, a current heading, and a current speed of the first device 102, as examples. The location unit 1020 can be implemented in many ways. For example, the location unit 1020 can function as at least a part of a global positioning system (GPS), an inertial navigation system, a cellular-tower location system, a pressure location system, or any combination thereof.

The location unit 1020 can include a location interface 1032. The location interface 1032 can be used for communication between the location unit 1020 and other functional units in the first device 102. The location interface 1032 can also be used for communication that is external to the first device 102.

The location interface 1032 can receive information from the other functional units or from external sources, or can transmit information to the other functional units or to external destinations. The external sources and the external destinations refer to sources and destinations external to the first device 102.

The location interface 1032 can include different implementations depending on which functional units or external units are being interfaced with the location unit 1020. The location interface 1032 can be implemented with technologies and techniques similar to the implementation of the first control interface 1022.

The first storage unit 1014 can store the first software 1026. The first storage unit 1014 can also store the relevant information, such as advertisements, point of interest (POI), navigation routing entries, reviews/ratings, feedback, traffic patterns, or any combination thereof

The first storage unit 1014 can be a volatile memory, a nonvolatile memory, an internal memory, an external memory, or a combination thereof. For example, the first storage unit 1014 can be a nonvolatile storage such as non-volatile random access memory (NVRAM), Flash memory, disk storage, or a volatile storage such as static random access memory (SRAM).

The first storage unit 1014 can include a first storage interface 1024. The first storage interface 1024 can be used for communication between the location unit 1020 and other functional units in the first device 102. The first storage interface 1024 can also be used for communication that is external to the first device 102.

The first storage interface 1024 can receive information from the other functional units or from external sources, or can transmit information to the other functional units or to external destinations. The external sources and the external destinations refer to sources and destinations external to the first device 102.

The first storage interface 1024 can include different implementations depending on which functional units or external units are being interfaced with the first storage unit 1014. The first storage interface 1024 can be implemented with technologies and techniques similar to the implementation of the first control interface 1022.

The first communication unit 1016 can enable external communication to and from the first device 102. For example, the first communication unit 1016 can permit the first device 102 to communicate with the second device 106 of FIG. 1, an attachment, such as a peripheral device or a computer desktop, and the communication path 104.

The first communication unit 1016 can also function as a communication hub allowing the first device 102 to function as part of the communication path 104 and not limited to be an end point or terminal unit to the communication path 104. The first communication unit 1016 can include active and passive components, such as microelectronics or an antenna, for interaction with the communication path 104.

The first communication unit 1016 can include a first communication interface 1028. The first communication interface 1028 can be used for communication between the first communication unit 1016 and other functional units in the first device 102. The first communication interface 1028 can receive information from the other functional units or can transmit information to the other functional units.

The first communication interface 1028 can include different implementations depending on which functional units are being interfaced with the first communication unit 1016. The first communication interface 1028 can be implemented with technologies and techniques similar to the implementation of the first control interface 1022.

The first user interface 1018 allows a user (not shown) to interface and interact with the first device 102. The first user interface 1018 can include an input device and an output device. Examples of the input device of the first user interface 1018 can include a keypad, a touchpad, soft-keys, a keyboard, a microphone, or any combination thereof to provide data and communication inputs.

The first user interface 1018 can include a first display interface 1030. The first display interface 1030 can include a display, a projector, a video screen, a speaker, or any combination thereof.

The first control unit 1012 can operate the first user interface 1018 to display information generated by the electronic system 100. The first control unit 1012 can also execute the first software 1026 for the other functions of the electronic system 100, including receiving location information from the location unit 1020. The first control unit 1012 can further execute the first software 1026 for interaction with the communication path 104 via the first communication unit 1016.

The second device 106 can be optimized for implementing the present invention in a multiple device embodiment with the first device 102. The second device 106 can provide the additional or higher performance processing power compared to the first device 102. The second device 106 can include a second control unit 1034, a second communication unit 1036, and a second user interface 1038.

The second user interface 1038 allows the user to interface and interact with the second device 106. The second user interface 1038 can include an input device and an output device. Examples of the input device of the second user interface 1038 can include a keypad, a touchpad, soft-keys, a keyboard, a microphone, or any combination thereof to provide data and communication inputs. Examples of the output device of the second user interface 1038 can include a second display interface 1040. The second display interface 1040 can include a display, a projector, a video screen, a speaker, or any combination thereof.

The second control unit 1034 can execute a second software 1042 to provide the intelligence of the second device 106 of the electronic system 100. The second software 1042 can operate in conjunction with the first software 1026. The second control unit 1034 can provide additional performance compared to the first control unit 1012.

The second control unit 1034 can operate the second user interface 1038 to display information. The second control unit 1034 can also execute the second software 1042 for the other functions of the electronic system 100, including operating the second communication unit 1036 to communicate with the first device 102 over the communication path 104.

The second control unit 1034 can be implemented in a number of different manners. For example, the second control unit 1034 can be a processor, an embedded processor, a microprocessor, a hardware control logic, a hardware finite state machine (FSM), a digital signal processor (DSP), or a combination thereof.

The second control unit 1034 can include a second controller interface 444. The second controller interface 444 can be used for communication between the second control unit 1034 and other functional units in the second device 106. The second controller interface 444 can also be used for communication that is external to the second device 106.

The second controller interface 444 can receive information from the other functional units or from external sources, or can transmit information to the other functional units or to external destinations. The external sources and the external destinations refer to sources and destinations external to the second device 106.

The second controller interface 444 can be implemented in different ways and can include different implementations depending on which functional units or external units are being interfaced with the second controller interface 444. For example, the second controller interface 444 can be implemented with a pressure sensor, an inertial sensor, a microelectromechanical system (MEMS), optical circuitry, waveguides, wireless circuitry, wireline circuitry, or a combination thereof.

A second storage unit 1046 can store the second software 1042. The second storage unit 1046 can also store the relevant information, such as advertisements, points of interest, navigation routing entries, reviews/ratings, feedback, traffic patterns, or any combination thereof. The second storage unit 1046 can be sized to provide the additional storage capacity to supplement the first storage unit 1014.

For illustrative purposes, the second storage unit 1046 is shown as a single element, although it is understood that the second storage unit 1046 can be a distribution of storage elements. Also for illustrative purposes, the electronic system 100 is shown with the second storage unit 1046 as a single hierarchy storage system, although it is understood that the electronic system 100 can have the second storage unit 1046 in a different configuration. For example, the second storage unit 1046 can be formed with different storage technologies forming a memory hierarchal system including different levels of caching, main memory, rotating media, or off-line storage.

The second storage unit 1046 can be a volatile memory, a nonvolatile memory, an internal memory, an external memory, or a combination thereof. For example, the second storage unit 1046 can be a nonvolatile storage such as non-volatile random access memory (NVRAM), Flash memory, disk storage, or a volatile storage such as static random access memory (SRAM).

The second storage unit 1046 can include a second storage interface 1048. The second storage interface 1048 can be used for communication between the location unit 1020 and other functional units in the second device 106. The second storage interface 1048 can also be used for communication that is external to the second device 106.

The second storage interface 1048 can receive information from the other functional units or from external sources, or can transmit information to the other functional units or to external destinations. The external sources and the external destinations refer to sources and destinations external to the second device 106.

The second storage interface 1048 can include different implementations depending on which functional units or external units are being interfaced with the second storage unit 1046. The second storage interface 1048 can be implemented with technologies and techniques similar to the implementation of the second controller interface 444.

The second communication unit 1036 can enable external communication to and from the second device 106. For example, the second communication unit 1036 can permit the second device 106 to communicate with the first device 102 over the communication path 104.

The second communication unit 1036 can also function as a communication hub allowing the second device 106 to function as part of the communication path 104 and not limited to be an end point or terminal unit to the communication path 104. The second communication unit 1036 can include active and passive components, such as microelectronics or an antenna, for interaction with the communication path 104.

The second communication unit 1036 can include a second communication interface 1050. The second communication interface 1050 can be used for communication between the second communication unit 1036 and other functional units in the second device 106. The second communication interface 1050 can receive information from the other functional units or can transmit information to the other functional units.

The second communication interface 1050 can include different implementations depending on which functional units are being interfaced with the second communication unit 1036. The second communication interface 1050 can be implemented with technologies and techniques similar to the implementation of the second controller interface 444.

The first communication unit 1016 can couple with the communication path 104 to send information to the second device 106 in the first device transmission 1008. The second device 106 can receive information in the second communication unit 1036 from the first device transmission 1008 of the communication path 104.

The second communication unit 1036 can couple with the communication path 104 to send information to the first device 102 in the second device transmission 1010. The first device 102 can receive information in the first communication unit 1016 from the second device transmission 1010 of the communication path 104. The electronic system 100 can be executed by the first control unit 1012, the second control unit 1034, or a combination thereof.

For illustrative purposes, the second device 106 is shown with the partition having the second user interface 1038, the second storage unit 1046, the second control unit 1034, and the second communication unit 1036, although it is understood that the second device 106 can have a different partition. For example, the second software 1042 can be partitioned differently such that some or all of its function can be in the second control unit 1034 and the second communication unit 1036. Also, the second device 106 can include other functional units not shown in FIG. 3 for clarity.

The functional units in the first device 102 can work individually and independently of the other functional units. The first device 102 can work individually and independently from the second device 106 and the communication path 104.

The functional units in the second device 106 can work individually and independently of the other functional units. The second device 106 can work individually and independently from the first device 102 and the communication path 104.

For illustrative purposes, the electronic system 100 is described by operation of the first device 102 and the second device 106. It is understood that the first device 102 and the second device 106 can operate any of the modules and functions of the electronic system 100. For example, the first device 102 is described to operate the location unit 1020, although it is understood that the second device 106 can also operate the location unit 1020.

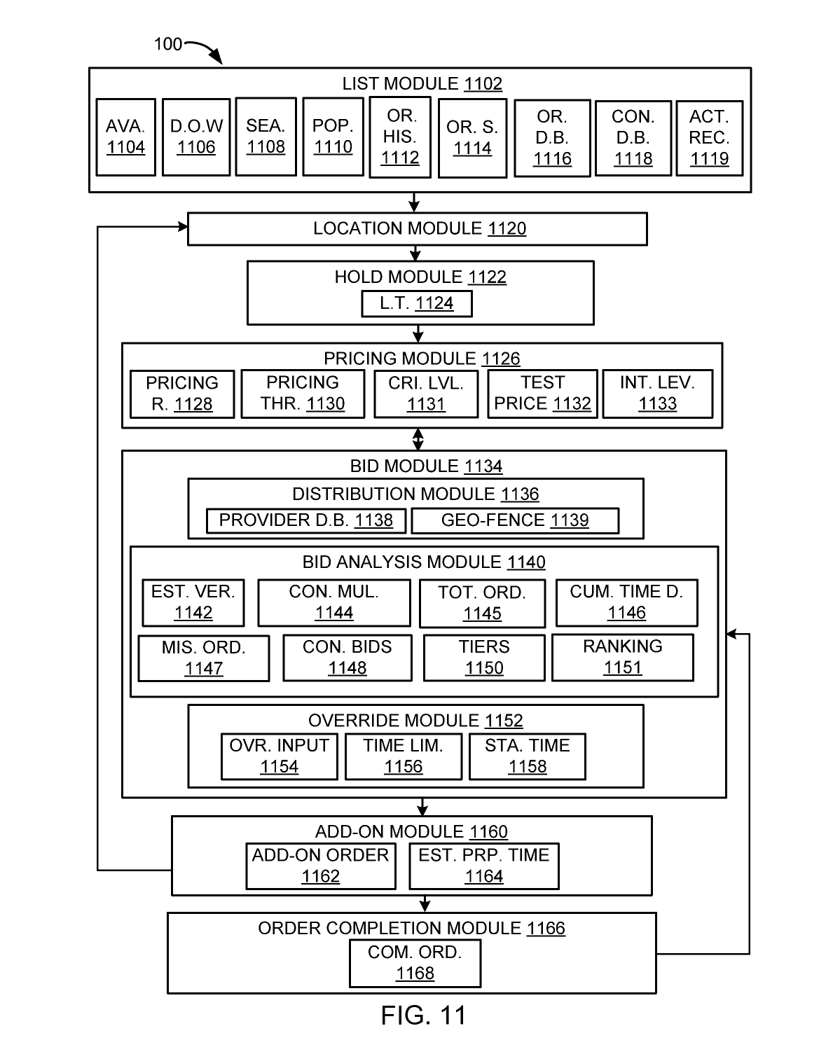

Referring now to FIG. 11, therein is shown a control flow of the electronic system 100 with a temporal bidding mechanism. The electronic system 100 can include a list module 1102, a location module 1120, a hold module 1122, a pricing module 1126, a bid module 1134, an add-on module 1160, an order completion module 1166, or a combination thereof.

The modules noted above and below are coupled to one another by having an operation of one module influence an operation of another module or other modules, by having an output of one module as an input of another module or other modules using wired or wireless connections, or a combination thereof. As an example, portions of the electronic system 100 can be implemented using an object-oriented programming language such as Objective-C, C++, Java, C#, Python, Ruby, or a combination thereof

The list module 1102 is for generating the goods list 304 of FIG. 3 and identifying the order 206 of FIG. 2 from the consumer 208 of FIG. 2. For example, the goods list 304 can be a restaurant menu, a parts list, an offerings list, a work order, or a combination thereof. The goods list 304 can be displayed through the order page of FIG. 3 implemented using HyperText Markup Language (HTML), Cascading Style Sheets (CSS), Extensible Markup Language (XML), JavaScript, or a combination thereof.

The list module 1102 can generate the goods list 304 by displaying the good 210 of FIG. 2 being offered by a plurality of the goods provider 216 of FIG. 2. The list module 1102 can dynamically adjust the good 210 included on the goods list 304 based on an availability 1104 of the goods provider 216. The availability 1104 of the goods provider 216 refers to a capability of the goods provider 216 to produce or provide the good 210 listed on the goods list 304. For example, the availability 1104 can refer to an availability of resources, staff, or a combination thereof of the goods provider 216 to produce the good 210. As a more specific example, the availability 1104 can refer to a restaurant's inability to cook a certain item due to the unavailability of a raw ingredient.

The list module 1102 can determine the availability 1104 of the goods provider 216 to provide or produce the good 210 based on an input received at a device in the electronic system 100, a count of the good 210 ordered in a previous time period, or a combination thereof. The list module 1102 can conduct the count at predetermined intervals established by the electronic system 100. For example, a restaurant worker can inform the electronic system 100 of a raw ingredient shortage by clicking on an icon using the first user interface 1018 of FIG. 10, the second user interface 1038 of FIG. 10, or a combination thereof.

The list module 1102 can also determine the adjustable price 306 of FIG. 3 for the good 210 shown on the goods list 304. The list module 1102 can display the adjustable price 306 as the price bracket 308 of FIG. 3, the price range 310 of FIG. 3, the approximate price 312 of FIG. 3, or a combination thereof. The list module 1102 can determine the adjustable price 306 based on the order time 328 of FIG. 3, the availability 1104 of the goods provider 216, a day-of-the-week 1106, a season 1108, a popularity 1110 of the good 210, or a combination thereof. The list module 1102 can determine the adjustable price 306 by increasing or decreasing the adjustable price 306 as a result of the order time 328, the availability 1104 of the goods provider 216, the day-of-the-week 1106, the season 1108, the popularity 1110 of the good 210, or a combination thereof.

The day-of-the-week 1106 can refer to any of the seven days of the week. The list module 1102 can increase the adjustable price 306 by determining whether the day-of-the week 1106 is a weekend. If the list module 1102 determines the day-of-the-week 1106 is a weekend, the list module 1102 can automatically increase the adjustable price 306. As a more specific example, the list module 1102 can increase the adjustable price 306 of restaurant dishes on a Saturday because the increase in dine-in patrons on the weekend makes satisfying delivery or takeout orders more difficult.

Moreover, the list module 1102 can analyze the total number of orders for the good 210 on each of the day-of the-week 1106. The list module 1102 can increase the adjustable price 306 for the good 210 on the day-of-the-week 1106 with the most orders for the good 210 based on an order history 1112 for the good 210. The order history 1112 is information or data concerning past orders for the good 210.

The order history 1112 can include the total number of orders for the good 210 in a given period. The order history 1112 can also include changes in the number of orders for the good 210 in a given period. The order history 1112 can also include information concerning the destination location 218 of past orders, the age and demographic of consumers who have ordered the good 210, the order time 328 of past orders, or a combination thereof.

In addition, the list module 1102 can interact with a third-party reservation service to obtain information on the number of upcoming reservations for the goods provider 216. For example, the list module 1102 can interact with an online reservation system such as OpenTable™ to obtain information on the number of reservations for a restaurant on a particular day.

The list module 1102 can increase the adjustable price 306 of the good 210 when the number of reservations for the goods provider 216 exceeds a daily average. The daily average can be calculated by dividing the total number of reservations in the preceding week by 7. As an additional example, the daily average can be calculated by dividing the total number of reservations in the preceding month by 30. The list module 1102 can apply a machine learning mechanism, a pattern recognition mechanism, or a combination thereof to establish rules or triggers concerning when to increase or decrease the adjustable price 306 as a result of the day-of-the week 1106.

In addition, the list module 1102 can increase or decrease the adjustable price 306 of the good 210 as the season 1108 changes. The season 1108 is a time of year characterized by a particular occasion or circumstance. The season 1108 can include a time of year characterized by a weather pattern, a religious or social occasion, an activity, or a combination thereof. The list module 1102 can increase the adjustable price 306 of the good 210 by analyzing seasonal sales data for the good 210. The seasonal sales data can be collected by the electronic system 100 based on past orders.

For example, the season 1108 can include a shopping season, Christmas, New Year's, or a combination thereof. As a more specific example, the adjustable price 306 of flowers can increase during a holiday such as Valentine's day or Mother's day. The list module 1102 can interact with a calendar program or application on the first device 102, the second device 106, or a combination thereof to determine the season 1108.

Moreover, the list module 1102 can increase or decrease the adjustable price 306 of the good 210 based on the popularity 1110 of the good 210. The popularity 1110 refers to the demand for a good from purchasers. The list module 1102 can increase the adjustable price 306 of the good 210 when the list module 1102 detects a rise in the number of orders for the good 210 during a predefined time period. The predefined time period can include an hour, a day, or a week. The list module 1102 can increase the adjustable price 306 of the good 210 when the list module 1102 detects a rise in the number of orders for the good 210 above an hourly average, a daily average, or a weekly average.

For example, the list module 1102 can increase the adjustable price 306 of an appetizer when the list module 1102 detects a rise in orders for the appetizer during a 24 hour period. In addition, the list module 1102 can increase the adjustable price for an entrée when the list module 1102 detects the number of orders for the entrée exceeding a weekly average over a seven day period.

The list module 1102 can store the adjustable price 306, the goods list 304, or a combination thereof in a list database or in an external database accessible to the electronic system 100. The list database can be stored in the first storage unit 1014 of FIG. 10, the second storage unit 1046 of FIG. 10, or a combination thereof. The list database can be implemented as a relational database, a key-value database, an array database, a columnar database, an object oriented database, or a combination thereof. As a more specific example, the relational database can be a Structured Query Language (SQL) database.

The list module 1102 can identify the order 206 for the good 210 by processing an order selection 1114. The order selection 1114 is an input for placing or compiling the order 206. The list module 1102 can receive the order selection 1114 from a user input applied to the order page 302 or from a device in the electronic system 100.

For example, the order selection 1114 can include a click input, a gesture input, a touch input, a swipe input, or a combination thereof received at the order page 302 through the first user interface 1018, the second user interface 1038, or a combination thereof. In addition, the order selection 1114 can also include an audio input received through an audio receiver coupled to the first control interface 1028 of FIG. 10, the second control interface 1044 of FIG. 10, or a combination thereof.

The list module 1102 can also predict the order selection 1114 based on an activity record 1119 of the consumer 208 or another user of the electronic system 100. The activity record 1119 refers to a history of past orders placed by the consumer 208 or another user of the electronic system 100 using the electronic system 100. The list module 1102 can predict the order selection 1114 by analyzing the most ordered goods by the consumer 208 from the activity record 1119. The list module 1102 can display a predicted instance of the order selection 1114 on the order page 302 as a recommendation. For example, the list module 1102 can display the recommendation for a large one topping pizza to the consumer 208 based on the number of times the consumer 208 ordered the same item from the activity record 1119.

The activity record 1119 can be stored in a consumer database 1118. The consumer database 1118 is a database storing information concerning the consumer 208 or other users of the electronic system 100. For example, the consumer database 1118 can include a past delivery address, a preferred delivery address, or a combination thereof. In addition, the consumer database 1118 can include a record of past orders made by the consumer 208.

The consumer database 1118 can be implemented as a relational database, a key-value database, an array database, a columnar database, an object oriented database, or a combination thereof. As a more specific example, the relational database can be a Structured Query Language (SQL) database. The consumer database 1118 can be stored in the first storage unit 1014, the second storage unit 1046, or a combination thereof.

The order selection 1114 can include an amount of the good 210 desired by the consumer 208. Upon receiving the order selection 1114, the list module 1102 can display a total instance of the adjustable price 306 on the order page 302. The order selection 1114 can be stored in an order database 1116 or in an external database accessible to the electronic system 100. The order database 1116 can be stored in the first storage unit 1014, the second storage unit 1046, or a combination thereof. The order database 1116 can be implemented as a relational database, a key-value database, an array database, a columnar database, an object oriented database, or a combination thereof. The order database 1116 can also be part of the list database.

The list module 1102 can be part of the first software 1026, the second software 1042, or a combination thereof. The first control unit 1012 can execute the first software 1026, the second control unit 1034 can execute the second software 1042, or a combination thereof to generate the goods list 304, determine the adjustable price 306, receive the order selection 1114, or a combination thereof.

The list module 1102 can also communicate or receive the goods list 304, the adjustable price 306, the order selection 1114, or a combination thereof between devices through the first communication unit 1016, the second communication unit 1036, or a combination thereof. After generating the goods list 304 and determining the adjustable price 306, the control flow can pass from the list module 1102 to the location module 1120.

The location module 1120 is for determining the destination location 218 of FIG. 2. As noted above, the destination location 218 can be a residential address, a work or occupational address, a commercial address, or a geographic coordinate. The location module 1120 can determine the destination location 218 based on a text input received from the consumer 208. For example, the consumer 208 can type an address into a text input box displayed on the address page of FIG. 4. The location module 1120 can also determine the destination location 218 by retrieving the destination location 218 from the consumer database 1118.

The destination location 218 can also be the current location 404 of FIG. 4 of the consumer 208. The location module 1120 can interact with the location unit 1020 of FIG. 10 to obtain the current location 404 of the consumer 208. The current location 404 can be the coordinate location of the first device 102 carried by the consumer 208. The location module 1120 can also receive the destination location 218 from another device in the electronic system 100. The location module 1120 can store the destination location 218, the current location 404, or a combination thereof in the order database 1116, the consumer database 1118, an external database accessible to the electronic system 100, or a combination thereof.

As an additional example, the location module 1120 can determine the destination location 218 from an address book stored in the first device 102, the second device 106, or a combination thereof. Moreover, the location module 1120 can determine the destination location 218 from interacting with an application on the first device 102, the second device 106, or a combination thereof through an application programming interface (API).

The location module 1120 can also receive the destination location 218 through a user input, such as a click input, a gesture input, a touch input, a swipe input, or a combination thereof, received at an icon or graphic indicating a previously stored instance of the destination location 218. The location module 1120 can receive the user input through the first user interface 1018, the second user interface 1038, or a combination thereof. As yet another example, the destination location 218 can be received as an audio input through the audio receiver coupled to the first control interface 1028, the second control interface 1044, or a combination thereof

The location module 1120 can also display the destination location 218 on a map display. The location module 1120 can retrieve the map display from a mapping service including Google Maps™, Mapquest™, or a combination thereof. The location module 1120 can interact with the mapping service through a mapping API.

The location module 1120 can be part of the first software 1026, the second software 1042, or a combination thereof. The first control unit 1012 can execute the first software 1026, the second control unit 1034 can execute the second software 1042, or a combination thereof to determine the destination location 218, the current location 404, or a combination thereof.

The location module 1120 can also communicate or receive the destination location 218 between devices through the first communication unit 1016, the second communication unit 1036, or a combination thereof. After determining the destination location 218, the control flow can pass from the location module 1120 to the hold module 1122.

The hold module 1122 is for holding the order 206 of the consumer 208 to be processed at a later time 1124. The later time 1124 refers to a point in time after the order selection 1114 is made. The hold module 1122 can receive the later time 1124 from the consumer 208 or from a device in the electronic system 100. For example, the consumer 208 can make the order selection 1114 at 4 pm and request the electronic system 100 hold the order 206 to be processed at 6 pm. Processing the order 206 can include determining the final price 504 of FIG. 5 of the order 206, submitting the order 206 out for bidding by a plurality of the goods provider 216, or a combination thereof. Determining the final price 504 of the order 206 and submitting the order 206 out for bidding will be discussed in detail in later sections.

The hold module 1122 can receive a request to process the order 206 at a later time 1124 through the first user interface 1018, the second user interface 1038, or a combination thereof. For example, the hold module 1122 can receive a user input from the consumer 208 at the hold icon 406 of FIG. 4 displayed on the location page 402. The user input can include a click input, a gesture input, a swipe input, or a combination thereof. As an additional example, the hold module can receive the request to process the order 206 at a later time 1124 from an audio input received through an audio receiver coupled to the first control interface 1028 of FIG. 10, the second control interface 1044 of FIG. 10, or a combination thereof.

The hold module 1122 can hold the order 206 by storing the order selection 1114, the adjustable price 306, the destination location 218, or a combination thereof in the order database 1116. The hold module 1122 can also modify the adjustable price 306 if the availability 1104 of the goods provider 216, the popularity 1110 of the good 210 included in the order selection 1114, or combination thereof changes between the current time and the later time 1124.

For example, the hold module 1122 can modify the adjustable price 306 by raising or lowering the adjustable price 306. As a more specific example, the hold module 1122 can lower the adjustable price 306 from the low price 316 to the high price 314 if the availability 1104 of an ingredient required to produce the good 210 is in short supply. As an additional example, the hold module 1122 can raise the adjustable price 316 from the low price 316 to the intermediate price 318 if the hold module 1122 detects a decrease in the popularity 1110 of the good 210.

The hold module 1122 can pass the control flow to the pricing module 1126 when the later time 1124 is reached. For example, the hold module 1122 can pass the order selection 1114, the adjustable price 306, the destination location 218, or a combination thereof as an output from the hold module 1122 to an input of the pricing module 1126.

The hold module 1122 can be part of the first software 1026, the second software 1042, or a combination thereof. The first control unit 1012 can execute the first software 1026, the second control unit 1034 can execute the second software 1042, or a combination thereof to process the order 206 at the later time 1124. The hold module 1122 can also communicate or receive the later time 1124, the order selection 1114, the adjustable price 306, the destination location 218, or a combination thereof between devices through the first communication unit 1016, the second communication unit 1036, or a combination thereof.

The pricing module 1126 is for determining the final price 504. The pricing module 1126 can determine the final price 504 in several ways. The pricing module 1126 can determine the final price 504 based on the adjustable price 306. For example, the pricing module 1126 can determine the final price 504 by setting any of the low price 316 of FIG. 3, the intermediate price 318 of FIG. 3, or the high price 314 of FIG. 3 as the final price 504.

In addition, the pricing module 1126 can determine the final price 504 by applying the price multiplier 320 of FIG. 3 to the low price 316, the intermediate price 318, the high price 314, or a combination thereof. As indicated above, the price multiplier 320 can include the low multiplier 324 of FIG. 3, the intermediate multiplier 326 of FIG. 3, or the high multiplier 322 of FIG. 3. The pricing module 1126 can apply the price multiplier 320 to the adjustable price 306 by multiplying the price multiplier 320 with the low price 316, the intermediate price 318, the high price 314, or a combination thereof.

The pricing module 1126 can also determine the final price 504 based on the order time 328, the availability 1104 of the goods provider 216, the day-of-the-week 1106, the season 1108, the popularity 1110 of the good 210, the pending orders 220 of FIG. 2, or a combination thereof. For example, the pricing module 1126 can determine the final price 504 by establishing pricing rules 1128, pricing thresholds 1130, or a combination thereof related to the order time 328, the availability 1104 of the goods provider 216, the day-of-the-week 1106, the season 1108, the popularity 1110 of the good 210, the pending orders 220, or a combination thereof. The pricing module 1126 can establish the pricing rules 1128, the pricing thresholds 1130, or a combination thereof using a machine learning mechanism, a pattern recognition mechanism, or a combination thereof.

The pricing rules 1128 are tenets governing when the price for a good can be raised or lowered. For example, the pricing rules 1128 can include a rule establishing all dishes on a menu be set to the high price 314 during meal times. As a more specific example, the pricing module 1126 can set one of the pricing rules 1128 as increase the price of lunch items between 11 am to 2 pm and increase the price of dinner items between 5 pm to 8 pm. Moreover, the pricing rules 1128 can include a rule establishing the high multiplier 322 is applied to all roses in a flower shop in the two week period preceding Valentine's day.

The pricing thresholds 1130 are minimum or maximum quantity values governing when the price for a product or item can be raised or lowered. For example, the pricing module 1126 can increase the price for the good 210 from the low price 316 to the intermediate price 318 when the quantity of the good 210 sold exceeds a predetermined threshold number. As a more specific example, the pricing module 1126 can increase the price for a baked good when more than 100 units of the baked good have been sold in the last 2 hours.

As an additional example, the pricing module 1126 can raise the price for all baked goods when the pending orders 220 for baked goods increases above a threshold amount. In addition, the pricing module 1126 can analyze past orders from the order database 1116 to determine the final price 504.

The pricing module 1126 can also determine the final price 504 by interacting with the bid module 1134. The pricing module 1126 can initially pass the control flow to the bid module 1134 without determining the final price 504. In this scenario, the pricing module 1126 can generate a test price 1132 for the good 210 for soliciting the temporal bid 214 from the goods provider 216. The test price 1132 is an preliminary price used to gauge the interest of the goods provider 216. The test price 1132 can be a price within the price bracket 308, the price range 310, or a combination thereof.

The pricing module 1126 can distribute the order 206 out to the goods provider 216 with the test price 1132 to determine an interest level 1133 in the order 206. The pricing module 1126 can increase the test price 1132 based on the interest level 1133. The interest level 1133 refers to the number of bids received for a good based on the price of the good. For example, the interest level 1133 can refer to an amount of a plurality of the temporal bid 214 of FIG. 2 received from a plurality of the goods provider 216 as a result of the test price 1132.

The test price 1132 can become the final price 504 when the interest level 1133 reaches a critical level 1131. The critical level 1131 refers to a threshold number of bids received from the plurality of the goods provider 216. For example, the pricing module 1126 can establish the critical level 1131 as a minimum of two instances of the temporal bid 214 where each instance of the temporal bid 214 includes a different instance of the bid time 604. As a more specific example, the critical level 1131 can be two bids if the bid time 604 of one of the bids is less than the other.

The pricing module 1126 can determine the critical level 1131 based on historical data concerning the number of bids received for the good 210. For example, the pricing module 1126 can determine the critical level 1131 by calculating an average number of bids received for the good 210 in the preceding two week period and establishing the average number of bids as the critical level 1131.

For example, the pricing module 1126 can initially establish the test price 1132 for a takeout order as the low price 316. The pricing module 1126 can then submit the order 206 with the test price 1132 to the goods provider 216 for bidding. If only one of the plurality of the goods provider 216 submits the temporal bid 214, the pricing module 1126 can increase the test price 1132 to either the intermediate price 318 or the high price 314 until an amount of the plurality of the temporal bid 214 received exceeds the critical level 1131.

The pricing module 1126 can determine the final price 504 in this manner to ensure multiple instances of the temporal bid 214 are received to offer the consumer 208 a choice in the goods provider 216. The pricing module 1126 can display the final price 504 through the compiled order page 502 of FIG. 5. When the final price 504 is displayed to the consumer 208, the pricing module 1126 can receive an input from the consumer 208 to send the order 206 out for bid.

The pricing module 1126 can be part of the first software 1026, the second software 1042, or a combination thereof. The first control unit 1012 can execute the first software 1026, the second control unit 1034 can execute the second software 1042, or a combination thereof to determine the final price 504.

The pricing module 1126 can also communicate or receive the final price 504 between devices through the first communication unit 1016, the second communication unit 1036, or a combination thereof. After determining the final price 504 the control flow can pass from the pricing module 1126 to the bid module 1134.

The bid module 1134 is for distributing the order 206 to the goods provider 216 for bidding on the order 206 and determining the winning bid 704 of FIG. 7. The bid module 1134 can include a distribution module 1136, a bid analysis module 1140, an override module 1152, or a combination thereof. The distribution module 1136 is for selecting the goods provider 216 who can bid on the order 206. The distribution module 1136 can select the goods provider 216 based on the destination location 218, the fulfillment history 708 of FIG. 7 of the goods provider 216, the review rating 710 of FIG. 7 of the goods provider 216, or a combination thereof.

The distribution module 1136 can select which of the plurality of the goods provider 216 can bid on the order 206 by generating a geo-fence 1139 around the destination location 218. The geo-fence 1139 is a virtual perimeter surrounding a geographic area in the real world. The geographic area of the geo-fence 1139 can be a circle, a polygon, or a combination thereof. The size of the geo-fence 1139 can be defined by a distance segment, such as a radius, stemming from a reference point. As a more specific example, the reference point of the geo-fence 1139 can be the destination location 218.

The distribution module 1136 can distribute the order 206 out for bidding to at least one of the plurality of the goods provider 216 located within the geo-fence 1139. For example, the distribution module 1136 can generate the geo-fence 1139 as a virtual perimeter surrounding a circular geographic area. In this example, the center point of the geo-fence 1139 can be the destination location 218 and the radius can be 10 miles. The distribution module 1136 can distribute the order 206 to at least one of the plurality of the goods provider 216 located within the 10 mile radius of the destination location 218.

The distribution module 1136 can receive the location of the goods provider 216 through the first communication unit 1016, the second communication 1036, or a combination thereof. In addition, the distribution module 1136 can retrieve the location of the goods provider 216 from a provider database 1138. The provider database 1138 is for storing and classifying information concerning the goods provider 216.

The provider database 1138 can be implemented as a relational database, a key-value database, an array database, a columnar database, an object oriented database, or a combination thereof. As a more specific example, the relational database can be a Structured Query Language (SQL) database. The provider database 1138 can be stored in the first storage unit 1014, the second storage unit 1046, or a combination thereof.

The distribution module 1136 can increase or decrease a radius of the geo-fence 1139 based on the order time 328 or the traffic condition. The distribution module 1136 can receive the traffic condition by accessing a mapping database such as Google Maps™, Mapquest™, Navteg™, or a combination thereof. The distribution module 1136 can interact with the mapping database through an API.

The distribution module 1136 can also select the goods provider 216 who can bid on the order 206 based on the fulfillment history 708. As noted above, the fulfillment history 708 can include data on how many orders have or have not been completed within the bid time 604 promised by the goods provider 216 in the temporal bid 214. In addition, the fulfillment history 708 can include data on the amount of time exceeded by the goods provider 216 in all instances where the order was not completed within the bid time 604.

The distribution module 1136 can exclude the goods provider 216 based on the fulfillment history 708 by establishing a minimum threshold for orders not completed within the bid time 604. For example, the distribution module 1136 can automatically exclude the goods provider 216 if the fulfillment history 708 of the goods provider 216 shows more than 10 orders where not completed within the bid time 604.

The distribution module 1136 can also select the goods provider 216 who can bid on the order 206 based on the review rating 710. The review rating 710 can be a rating from an external review service such as Yelp™, AngiesList™, or a combination thereof. The distribution module 1136 can access the external reviews of the goods provider 216 through an API of the external review service.

The review rating 710 can also be an internal rating received from the consumer 208 or another user of the electronic system 100. The distribution module 1136 can exclude the goods provider 216 based on the review rating 710 by establishing a rating threshold. For example, the distribution module 1136 can exclude the goods provider 216 if the goods provider 216 receives a Yelp™ rating below 2 stars.

When the distribution module 1136 has selected the goods provider 216 for bidding on the order 206, the bid module 1134 can transmit the order 206 to the goods provider 216 selected through the first communication unit 1016, the second communication unit 1036, or a combination thereof. In addition, the distribution module 1136 can store the fulfillment history 708, the review rating 710, or a combination thereof in the provider database 1138. The bid module 1134 can also transmit the order 206 to a device, such as the second device 106, accessible to the goods provider 216.

For example, the goods provider 216 can be a Chinese restaurant and the second device 106 can be a tablet device in the kitchen of the Chinese restaurant. In this example, the order 206 can be displayed on the second display interface 1040 of the second device 106 when the distribution module 1136 transmits the order 206 to the Chinese restaurant for bidding.

The bid analysis module 1140 is for identifying the temporal bid 214 from the goods provider 216 and determining the winning bid 704. The bid analysis module 1140 can identify the temporal bid 214 by collecting and storing the temporal bid 214 from the goods provider 216. The bid analysis module 1140 can receive the temporal bid 214 from a device in the electronic system 100.

The bid analysis module 1140 can determine the winning bid 704 based on the bid time 604, an estimated veracity 1142 of the goods provider 216, a review rating 710 of the goods provider 216, the activity record 1119 of the consumer 208, or a combination thereof.

The bid analysis module 1140 can determine the winning bid 704 based on the bid time 604. The bid analysis module 1140 can generate a ranking 1151 of the plurality of the temporal bid 214 based on the bid time 604. The ranking 1151 is a listing of the bids according to one or more criteria. The bid analysis module 1140 can choose as the winning bid 704 the temporal bid 214 with the lowest instance of the bid time 604 out of all bids received.

In addition, the bid analysis module 1140 can determine the winning bid 704 based on the bid time 604 and the estimated veracity 1142 of the goods provider 216. The bid analysis module 1140 can initially generate the raking 1151 of the plurality of the temporal bid 214 based on the bid time 604. The bid analysis module 1140 can then adjust the bid time 604 of the plurality of the temporal bid 214 based on the estimated veracity 1142 of the goods provider 216.

The estimated veracity 1142 refers to an estimated truthfulness of the goods provider 216 as it pertains to the bid time 604 of the temporal bid 214 submitted by the goods provider 216. The estimated veracity 1142 of the goods provider 216 can be determined based on the fulfillment history 708 of the goods provider 216.

The fulfillment history 708 can include data on the number of total orders 1145 and the number of missed orders 1147. The total orders 1145 refers to the aggregate number of orders fulfilled by the goods provider 216. The missed orders 1147 refers to the number of orders which have not been completed within the bid time 604 promised by the goods provider 216.

The fulfillment history 708 can also include a cumulative time differential 1146. The cumulative time differential 1146 is an aggregate differential between the actual completion time 910 of the missed orders 1147 and the bid time 604 of the missed orders 1147. For example, the goods provider 216 can be a restaurant and the fulfillment history 708 of the restaurant can indicate that two of the orders cooked by the restaurant were the missed orders 1147.

Continuing with the example, the fulfillment history 708 can also indicate that the actual completion time 910 of the first order exceeded the bid time 604 by 30 seconds and the actual completion time 910 of the second order exceeded the bid time 604 by 1 minute. In this example, the cumulative time differential 1146 for this restaurant would be 1.5 minutes.

The bid analysis module 1140 can adjust the bid time 604 of the plurality of the temporal bid 214 by applying a confidence multiplier 1144 to the bid time 604. The confidence multiplier 1144 is a numerical multiplier for adjusting the bid time 604 based on the estimated veracity 1142 of the goods provider 216. For example, the bid analysis module 1140 can apply the confidence multiplier 1144 of 1.2 to the bid time 604 of 8 minutes to obtain a new instance of the bid time 604 of 9.6 minutes.

The bid analysis module 1140 can assign a particular instance of the confidence multiplier 1144 to each of the plurality of the goods provider 216. The bid analysis module 1140 can generate the confidence multiplier 1144 by assigning a baseline instance of the confidence multiplier 1144, such as 1.00, to each of the plurality of the goods provider 216. The bid analysis module 1140 can then divide the cumulative time differential 1146 by an aggregate instance of the bid time 604 for the total orders 1145. Next, the bid analysis module 1140 can add the ratio of the cumulative time differential 1146 and the aggregate instance of the bid time 604 to the baseline instance of the confidence multiplier 1144.

The bid analysis module 1140 can apply the confidence multiplier 1144 to the bid time 604 by multiplying the confidence multiplier 1114 by the bid time 604. The bid analysis module 1140 can then generate the ranking 1151 based on an adjusted instance of the bid time 604.

For example, Joe's Pizzeria can submit an instance of the temporal bid 214 with a bid time 604 of 15 minutes and Vito's Pizzeria can submit another instance of the temporal bid 214 with a bid time 604 of 20 minutes. The bid analysis module 1140 can assign the confidence multiplier 1144 of 1.47 to Joe's Pizzeria and assign the confidence multiplier 1144 of 1.10 to Vito's Pizzeria based on the estimated veracity 1142 of the two restaurants. The bid analysis module 1140 can rank the temporal bid 214 from Vito's Pizzeria above the temporal bid 214 from Joe's Pizzeria in the ranking 1151 after applying the confidence multiplier 1144 to the bid time 604 of the two bids.

The bid analysis module 1140 can also determine the winning bid 704 by factoring in the review rating 710 of the goods provider 216. The bid analysis module 1140 can group the plurality of the goods provider 216 by tiers 1150 based on the review rating 710. The tiers 1150 refers to a grouping of the plurality of the goods provider 216 according to a predefined criteria. The bid analysis module 1140 can group the plurality of the goods provider 216 by the tiers 1150 based on the rating scale of the review rating 710.

For example, one of the tiers 1150 can include all 3-star restaurants on Yelp™ or all A+ rated businesses by the Better Business Bureau™. Each of the tiers 1150 can include business or organizations from multiple rating categories. For example, one of the tiers 1150 can include all restaurants rated 2-stars or below.

The bid analysis module 1140 can increment or decrement the confidence multiplier 1144 based on the tiers 1150. The bid analysis module 1140 can decrement the confidence multiplier 1144 by a fractional amount if the goods provider 216 is in a higher instance of the tiers 1150. The higher instance of the tiers 1150 can refer to a four-star restaurant or an A+ rating.

The bid analysis module 1140 can also determine the winning bid 704 by factoring in the activity record 1119 of the consumer 208. The bid analysis module 1140 can access the activity record 1119 of the consumer 208 from the consumer database 1118. The bid analysis module 1140 can decrement the confidence multiplier 1144 assigned to one of the plurality of the goods provider 216 if the activity record 1119 of the consumer 208 indicates a strong preference by the consumer 208 for the goods provider 216 as evidenced by the activity record 1119. The bid analysis module 1140 can also decrement the confidence multiplier 1144 assigned to one of the plurality of the goods provider 216 if the activity record 1119 indicates a strong dislike of the goods provider 216 by the consumer 208.

The bid analysis module 1140 can also use the ranking 1151 to determine several contending bids 1148 along with the winning bid 704. The contending bids 1148 are instances of the temporal bid 214 ranking close to the winning bid 704 but are not the winning bid 704. For example, the contending bids 1148 can be the first or second runner ups to the winning bid 704. After determining the winning bid 704, the bid analysis module 1140 can pass to the override module 1152.

The override module 1152 is for refusing or countermanding the winning bid 704 determined by the bid analysis module 1140. The override module 1152 can permit the consumer 208 or a device in the electronic system 100 to override the winning bid 704 and choose another one of the plurality of the goods provider 216 to fulfill the order 206. The override module 1152 can override the winning bid 704 by receiving an override input 1154 from the consumer 208 through the first user interface 1018, the second user interface 1038, or a combination thereof

The override input 1154 is a user input for overriding a decision by the electronic system 100. The override input 1154 can include a click input, a gesture input, a touch input, a swipe input, or a combination thereof received at an icon on the win confirmation page 702 of FIG. 7. For example, the icon can be a button with the words “Search for Another Restaurant” as shown in FIG. 7.

The override module 1152 can also permit the consumer 208 to manually select the goods provider 216 to fulfill the order 206. In addition, the consumer 208 can view the contending bids 1148 and select the goods provider 216 associated with one of the contending bids 1148 over the provider associated with the winning bid 704. The override module 1152 can then store the override input 1154 as part of a consumer profile associated with the consumer 208 in the consumer database 1118. In addition, the override module 1152 can also factor the override input 1154 into the review rating 710 of the goods provider 216 for subsequent orders.

The override module 1152 can also apply a time limit 1156 for the consumer 208 to override the winning bid 704. The time limit 1156 is a period of time during which the winning bid 704 can be overridden. For example, override module 1152 can set the time limit 1156 at 120 seconds and the consumer 208 can apply the override input 1154 within this 120 second period to refuse the winning bid 704.

If the consumer 208 does not apply the override input 1154 within the time limit 1156, the override module 1152 can inform the winner 706 of FIG. 7 to proceed with the order 206. In addition, the override module 1152 can inform the winner 706 to proceed with the order 206 if the override module 1152 receives an input from the consumer 208 or device in the electronic system 100 to proceed with the winning bid 704.

When the override module 1152 informs the winner 706 to proceed, the override module 1152 can also record the start time 1158 for the order 206. The override module 1152 can store the start time 1158 in the order database 1116.

The bid module 1134 can be part of the first software 1026, the second software 1042, or a combination thereof. The first control unit 1012 can execute the first software 1026, the second control unit 1034 can execute the second software 1042, or a combination thereof to determine the winning bid 704, the start time 1158, or a combination thereof.

The bid module 1134 can also communicate or receive the winning bid 704, the start time 1158, the contending bids 1148, or a combination thereof between devices through the first communication unit 1016, the second communication unit 1036, or a combination thereof. After determining the winning bid 704, the start time 1158, or a combination thereof the control flow can pass from the bid module 1134 to the add-on module 1160.

The add-on module 1160 is for generating the add-on offer 804 of FIG. 8 based on the order 206. The add-on module 1160 can display the add-on offer 804 through the alert 802 of FIG. 8. The add-on offer 804 can include the discount price 806 of FIG. 8 and the expiration time 808 of FIG. 8. The add-on module 1160 can generate the add-on offer 804 in several ways.

The add-on module 1160 can generate the add-on offer 804 based on the destination location 218 of the consumer 208 placing the order 206. The add-on module 1160 can interact with the location module 1120 to retrieve the destination location 218 of the consumer 208 placing the order 206.

The add-on module 1160 can then establish the geo-fence 1139 around the destination location 218. The add-on module 1160 can generate the alert 802 to display the add-on offer 804 when a device, such as the first device 102, the second device, 106, or a combination thereof, enters or is located within the geo-fence 1139. The add-on module 1160 can then send the alert 802 to the first device 102 through the first communication unit 1016, the second communication unit 1036, or a combination thereof. In this scenario, the first device 102 can be carried by a user of the electronic system 100.

In addition, the add-on module 1160 can query the consumer database 1118 and determine all previous users of the electronic system 100 with a stored delivery address within the geo-fence 1139. The add-on module 1160 can then send the alert 802 to the user associated with the stored delivery address. Alternatively, the add-on module 1160 can send the alert 802 to all users of the electronic system 100 without regard to location.

The add-on module 1160 can also determine the discount price 806 for the good 210 included in the add-on offer 804. For example, the add-on module 1160 can reduce the final price 504 by a multiplier such as the low multiplier 324 determined by the electronic system 100. As a more specific example, the add-on module 1160 can determine the discount price 806 as 50% of the final price 504. In addition, the add-on module 1160 can receive the discount price 806 from the goods provider 216. The add-on module 1160 can also determine the discount price 806 based on the availability 1104 of the winner 706. For example, the add-on module 1160 can receive an input from the winner 706 concerning the availability 1104 of resources needed to prepare or provide the good 210 included in the add-on offer 804.

The add-on module 1160 can receive an input from a user on the electronic system 100 to opt-in to the add-on offer 804. The add-on module 1160 can receive the input as a user input received through the first user interface 1018, the second user interface 1038, or a combination thereof. The add-on module 1160 can generate an add-on order 1162 for new orders received as a result of the add-on offer 804. The add-on order 1162 is an additional order for the good 210 included in an in-progress instance of the order 206. For example, the add-on order 1162 can be a delivery order for two rose bouquets when the order 206 involves a delivery order for a dozen rose bouquets. The add-on module 1160 can store the add-on order 1162 in the order database 1116.

The add-on module 1160 can also determine the expiration time 808 for the add-on offer 804. The add-on module 1160 can determine the expiration time 808 based on the availability 1104 of the winner 706, the bid time 604, the size of the geo-fence 1139, or a combination thereof. For example, the add-on module 1160 can determine the expiration time 808 as 40% of the bid time 604. In addition, the add-on module 1160 can increase the expiration time 808 when the size of the geo-fence 1139 increases. In any case, the add-on module 1160 can limit the expiration time 808 to a fraction of the bid time 604 to ensure the winner 706 can successfully complete the order 206 within the bid time 604.

The add-on module 1160 can also calculate an estimated preparation time 1164 for the add-on order 1162. For example, the add-on module 1160 can calculate the estimated preparation time 1164 based on the remainder of the bid time 604, the size of the add-on order 1162, or a combination thereof. The add-on module 1160 can display the estimated preparation time 1164 on the alert 802.

The add-on module 1160 can be part of the first software 1026, the second software 1042, or a combination thereof. The first control unit 1012 can execute the first software 1026, the second control unit 1034 can execute the second software 1042, or a combination thereof to generate the add-on offer 804, the add-on order 1162, or a combination thereof

The add-on module 1160 can also communicate or receive the add-on offer 804, the add-on order 1162, or a combination thereof between devices through the first communication unit 1016, the second communication unit 1036, or a combination thereof. After generating the add-on offer 804, the add-on order 1162, or a combination thereof the control flow can pass from the add-on module 1160 to the order completion module 1166.

The order completion module 1166 is for notifying the consumer 208 of a completed order 1168 and determining the estimated veracity 1142 of the winner 706. The completed order 1168 refers to one or more goods produced or prepared by the goods provider 216 to satisfy the order 206. For example, the completed order 1168 can include a prepared or assembled instance of the good 210 indicated in the order 206. As a more specific example, the completed order 1168 can include a cooked dish, an assembled basket of goods, a filled prescription, a floral arrangement, or a combination thereof.

The order completion module 1166 can notify the consumer 208 of the completed order 1168 when it receives the evidentiary content 904 of FIG. 9. The order completion module 1166 can also transmit the evidentiary content 904 to the consumer 208. The order completion module 1166 can receive the evidentiary content 904 when the goods provider 216 captures the evidentiary content 904 using the camera functionality 906 of FIG. 9 or uploads the evidentiary content 904 to the electronic system 100.

The camera functionality 906 can capture the evidentiary content 904 using a camera or video component coupled to the first control interface 1028 of FIG. 10, the second control interface 1044 of FIG. 10, or a combination thereof. The camera functionality 906 can also transmit the evidentiary content 904 to the electronic system 100 after capturing the evidentiary content 904. The camera functionality 906 can be initiated by a camera icon on the order completion module 1166. For example, the goods provider 216 can apply a click input to the camera icon to capture the evidentiary content 904.

As a more specific example, a chef of a restaurant can capture the evidentiary content 904 by taking a digital photograph of a cooked dish satisfying the order 206 using the camera functionality 906. In this example, the camera functionality 906 can be initiated by the chef clicking on the camera icon on the order confirmation page 902.

The order completion module 1166 can determine the actual completion time 910 by using the time at which the winner 706 captured the completed order 1168 using the camera functionality 906. In addition, the order completion module 1166 can also determine the actual completion time 910 based on a communication or input received from the winner 706.

The order completion module 1166 can interact with the bid module 1134 and pass the actual completion time 910 to the bid module 1134. The bid module 1134 can then determine the estimated veracity 1142 of the winner 706 based on the actual completion time 910.

The order completion module 1166 can also receive the override input 1154 from the consumer 208 to cancel the order 206 upon transmitting the evidentiary content 904. For example, the order completion module 1166 can receive the override input 1154 if the consumer 208 is dissatisfied with the order 206 as evidenced by the evidentiary content 904. The order completion module 1166 can interact with the bid module 1134 to re-initiate the bidding process in this scenario.

The order completion module 1166 can be part of the first software 1026, the second software 1042, or a combination thereof. The first control unit 1012 can execute the first software 1026, the second control unit 1034 can execute the second software 1042, or a combination thereof to notify the consumer 208 of the completed order 1168 and determine the estimated veracity 1142 of the winner 706. The bid module 1134 can also communicate or receive the evidentiary content 904, the estimated veracity 1142 of the winner 706, or a combination thereof between devices through the first communication unit 1016, the second communication unit 1036, or a combination thereof.

It has been discovered that determining the winning bid 704 based on multiple instances of the temporal bid 214 for completing the order 206 provides for an improved user experience pertaining to the purchase of goods. The electronic system 100 encourages the plurality of the goods provider 216 to compete for the order 206 of the consumer 208. This ensures that the expediency of the order 206 is a top priority for the goods provider 216.

It has further been discovered that determining the winning bid 704 based on multiple instances of the temporal bid 214 for completing the order 206 provides for more transactions on the electronic system 100. In the case where the electronic system 100 derives a transaction fee from a transaction, the number of transactions dictates the commercial success of the electronic system 100.

It has been discovered that determining the final price 504 for the good 210 by applying a price multiplier 320 to the adjustable price 306 provides for a more effective way to manage the supply and demand for orders on the electronic system 100. When the electronic system 100 notices a rise in orders for a particular instance of the good 210, the electronic system 100 can raise the price of the good 210 to ensure demand does not greatly exceed supply.

It has been discovered that generating a test price 1132 for the good 210 to determine the interest level 1133 from the goods provider 216 provides for a greater user experience. The consumer 208 benefits from having more instances of the temporal bid 214 for each instance of the order 206 placed by the consumer 208. The electronic system 100 can encourage more instances of the goods provider 216 to bid on the order 206 if the final price 504 reflects the market value of the good 210. The electronic system 100 can determine whether the final price 504 reflects the market value of the good 210 using the test price 1132.

It has been discovered that determining the winning bid 704 based on the bid time 604 of the temporal bid 214 provides for a more predictable gauge of the total number of orders that can be handled by the electronic system 100. The electronic system 100 can more easily predict the total number of orders that can be fulfilled by the plurality of the goods provider 216. The electronic system 100 can make this prediction based on the amount of the plurality of the goods provider 216 active on the electronic system 100 and their operating hours. This allows the electronic system 100 to more easily manage orders through the system.

It has been discovered that generating the add-on offer 804 based on the destination location 218 increases user engagement with the electronic system 100. Users of the electronic system 100 are more prone to engage with the electronic system 100 when there exists the possibility of an incoming instance of the add-on offer 804.

It has been discovered that adjusting the bid time 604 of the temporal bid 214 based on the confidence multiplier 1144 improves the user experience by ensuring that the bid time 604 of each instance of the temporal bid 214 is close to the actual completion time 910. By doing so, the electronic system 100 can ensure the accuracy of the bid time 604 of the winning bid 704.

The modules in FIG. 11 can be implemented by hardware acceleration units (not shown) in the control units. The modules in FIG. 1 can also be implemented by separate hardware units (not shown) outside the control units but with the first device 102 or the second device 106.

The modules described in this application can be implemented as instructions stored on a non-transitory computer readable medium to be executed by the first control unit 1012, the second control unit 1034, or a combination thereof. The non-transitory computer medium can include the first storage unit 1014, the second storage unit 1046, or a combination thereof. The non-transitory computer readable medium can include non-volatile memory, such as a hard disk drive, non-volatile random access memory (NVRAM), solid-state storage device (SSD), compact disk (CD), digital video disk (DVD), or universal serial bus (USB) flash memory devices. The non-transitory computer readable medium can be integrated as a part of the electronic system 100 or installed as a removable portion of the electronic system 100.

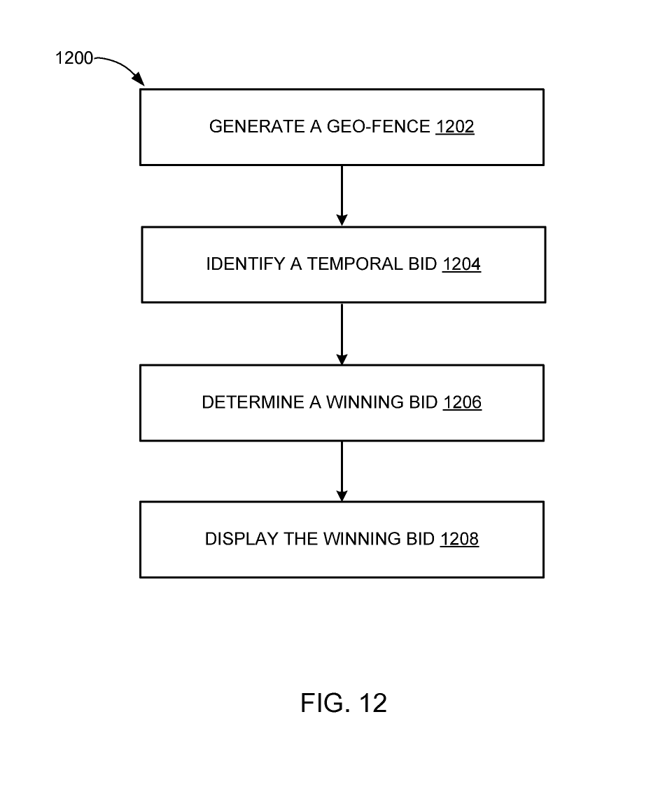

Referring now to FIG. 12, therein is shown a flow chart of a method 1200 of operation of the electronic system 100 in a further embodiment of the present invention. The method 1200 includes: generating the geo-fence 1162 around the destination location 218 for distributing the order 206 for the good 210 to the goods provider 216 located within the geo-fence 1162 in a block 1202; identifying the temporal bid 214 for bidding on the order 206 from the goods provider 216 in a block 1204; determining the winning bid 704 based on the bid time 604 of the temporal bid 214 in a block 1206; and displaying, with the first display interface 1030, the winning bid 704 in a block 1208.

The resulting method, process, apparatus, device, product, and/or system is straightforward, cost-effective, uncomplicated, highly versatile, accurate, sensitive, and effective, and can be implemented by adapting known components for ready, efficient, and economical manufacturing, application, and utilization. Another important aspect of the present invention is that it valuably supports and services the historical trend of reducing costs, simplifying systems, and increasing performance. These and other valuable aspects of the present invention consequently further the state of the technology to at least the next level.

While the invention has been described in conjunction with a specific best mode, it is to be understood that many alternatives, modifications, and variations will be apparent to those skilled in the art in light of the foregoing description. Accordingly, it is intended to embrace all such alternatives, modifications, and variations that fall within the scope of the included claims. All matters hithertofore set forth herein or shown in the accompanying drawings are to be interpreted in an illustrative and non-limiting sense.

What is claimed is:

1. An electronic system comprising:
a control unit, configured to:
generate a geo-fence around a destination location for distributing an order for a good to a goods provider located within the geo-fence;
identify a temporal bid for bidding on the order from the goods provider;
determine a winning bid based on a bid time of the temporal bid; and
a display interface, coupled to the control unit, configured to:
display the winning bid.

2. The system as claimed in claim 1 wherein the control unit is configured to adjust the bid time of the temporal bid by applying a confidence multiplier to the bid time based on an estimated veracity of the goods providers.

3. The system as claimed in claim 1 wherein the control unit is configured to generate an alert associated with the order for notifying a device located within the geo-fence.

4. The system as claimed in claim 1 wherein the control unit is configured to:
generate an adjustable price for the order;
identify an order selection based on the adjustable price;
determine a final price for the order based on the order selection and the adjustable price; and
distribute the order to the goods provider with the final price.

5. The system as claimed in claim 1 wherein the control unit is configured to:
generate a test price for the order;
distribute the order to the goods provider with the test price;
determine an interest level from the goods provider for the order based on the test price; and
set the test price as the final price when the interest level reaches a critical level.

6. The system as claimed in claim 1 wherein the control unit is configured to determine a final price for the order by applying a price multiplier to an adjustable price for the order based on a popularity of the good in the order, pending orders for the good in the order, or a combination thereof.

7. The system as claimed in claim 1 wherein the control unit is configured to determine the winning bid based on a veracity score, a veracity level, or a combination thereof of the goods provider.

8. The system as claimed in claim 1 wherein the control unit is configured to determine the winning bid based on a fulfillment history, a review rating, or a combination thereof of the goods provider.

9. The system as claimed in claim 1 wherein the control unit is configured to:
capture an evidentiary content associated with the order; and
identify an override input concerning the order based on the evidentiary content.

10. The system as claimed in claim 1 wherein the control unit is configured to:
generate a goods list for listing the good;
determine an adjustable price for pricing the good in the goods list; and
determine a final price for pricing the good in the goods list based on an order time, the adjustable price, or a combination thereof.

11. A method of operation of an electronic system comprising:
generating, with a control unit, a geo-fence around a destination location for distributing an order for a good to a goods provider located within the geo-fence;
identifying a temporal bid for bidding on the order from the goods provider;
determining a winning bid based on a bid time of the temporal bid; and
displaying, with a display interface, the winning bid.

12. The method as claimed in claim 11 further comprising adjusting the bid time of the temporal bid by applying a confidence multiplier to the bid time based on an estimated veracity of the goods providers.

13. The method as claimed in claim 11 further comprising generating an alert associated with the order for notifying a device located within the geo-fence.

14. The method as claimed in claim 11 further comprising:
generating an adjustable price for the order;
identifying an order selection based on the adjustable price;
determining a final price for the order based on the order selection and the adjustable price; and
distributing the order to the goods provider with the final price.

15. The method as claimed in claim 11 further comprising:
generating a test price for the order;
distributing the order to the goods provider with the test price;
determining an interest level from the goods provider for the order based on the test price; and
setting the test price as the final price when the interest level reaches a critical level.

16. A non-transitory computer readable medium, including instructions for execution, comprising:
generating a geo-fence around a destination location for distributing an order for a good to a goods provider located within the geo-fence;
identifying a temporal bid for bidding on the order from the goods provider;
determining a winning bid based on a bid time of the temporal bid; and
displaying the winning bid.

17. The non-transitory computer readable medium as claimed in claim 16 further comprising adjusting the bid time of the temporal bid by applying a confidence multiplier to the bid time based on an estimated veracity of the goods providers.

18. The non-transitory computer readable medium as claimed in claim 16 further comprising generating an alert associated with the order for notifying a device located within the geo-fence.

19. The non-transitory computer readable medium as claimed in claim 16 further comprising:
generating an adjustable price for the order;
identifying an order selection based on the adjustable price;
determining a final price for the order based on the order selection and the adjustable price; and
distributing the order to the goods provider with the final price.

20. The non-transitory computer readable medium as claimed in claim 16 further comprising:
generating a test price for the order;
distributing the order to the goods provider with the test price;
determining an interest level from the goods provider for the order based on the test price; and
setting the test price as the final price when the interest level reaches a critical level.
